(19) United States
(12) Patent Application Publication
(10) Pub. No.: US 2026/0018997 A1
(43) Pub. Date: Jan. 15, 2026

(54) POWER SUPPLY CONTROL DEVICE

(71) Applicant: ROHM CO., LTD., Kyoto (JP)

(72) Inventor: Shun FUKUSHIMA, Kyoto (JP)

(21) Appl. No.: 19/259,337

(22) Filed: Jul. 3, 2025

(30) Foreign Application Priority Data
Jul. 10, 2024 (JP) 2024-110942

(51) Int. Cl. H02M 3/157; H02M 3/158

(52) U.S. Cl. CPC H02M 3/157; H02M 3/158

(57) ABSTRACT

A power supply control device includes: an output stage circuit having a high-side transistor provided between an application terminal of an input voltage and a switch terminal, and a low-side transistor provided between the switch terminal and a ground terminal; a high-side driver; a low-side driver; a switching control circuit for controlling on/off state of the high-side and low-side transistors using the low-side and high-side drivers; a boot terminal for applying a boot voltage; a rectifying element for supplying a charging current to a boot capacitor during an on period of the low-side transistor; a reverse current detection circuit for detecting a specific reverse current state in which a reverse current flows from an output terminal to which the output voltage is applied, toward the low-side transistor via the coil and the switch terminal; and a monitor circuit for monitoring a height of the boot voltage.

### CROSS-REFERENCE TO RELATED APPLICATION

The present invention claims priority under 35 U.S.C. § 119 to Japanese Patent Application No. 2024-110942, filed on Jul. 10, 2024, the entire contents of which are incorporated herein by reference.

### TECHNICAL FIELD

The present disclosure relates to a power supply control device.

### BACKGROUND

In a switching power supply device including an output stage circuit configured by connecting a high-side transistor and a low-side transistor in series, a high-side driver that drives a gate of the high-side transistor, and a low-side driver that drives a gate of the low-side transistor, a boost circuit, which may also be referred to as a bootstrap circuit, is used to generate a power supply voltage on the high potential side of the high-side driver.

### BRIEF DESCRIPTION OF DRAWINGS

The accompanying drawings, which are incorporated in and constitute a part of the specification, illustrate embodiments of the present disclosure.

FIG. 1 is an overall configuration diagram of a switching power supply device according to a first embodiment of the present disclosure.

FIG. 2 is a diagram showing a relationship between several signals in a power supply control device according to the first embodiment of the present disclosure.

FIG. 3 is a diagram showing a relationship between a monitoring target voltage and a protection signal according to the first embodiment of the present disclosure.

FIG. 4 is an explanatory diagram of a normal mode and a sleep mode according to the first embodiment of the present disclosure.

FIG. 5 is a diagram showing an example of an internal configuration of a PWM circuit according to the first embodiment of the present disclosure.

FIG. 6 is a diagram showing how a control signal is generated by a pulse width modulation method according to the first embodiment of the present disclosure.

FIG. 7 is a timing chart in a vicinity of a start of switching control according to Example EX1_1 belonging to the first embodiment of the present disclosure.

FIG. 8 is another timing chart in the vicinity of the start of switching control according to Example EX1_1 belonging to the first embodiment of the present disclosure.

FIG. 9 is a configuration diagram of a reverse current detection circuit according to Example EX1_2 belonging to the first embodiment of the present disclosure.

FIG. 10 is a diagram showing how a current threshold value of the reverse current detection circuit is variably set, according to Example EX1_2 belonging to the first embodiment of the present disclosure.

FIG. 11 is a timing chart in a vicinity of a start of switching control according to Example EX1_2 belonging to the first embodiment of the present disclosure.

FIG. 12 is a state transition diagram of a logic circuit according to Example EX1_3 belonging to the first embodiment of the present disclosure.

FIG. 13 is a state transition diagram of a logic circuit according to Example EX1_4 belonging to the first embodiment of the present disclosure.

FIG. 14 is an operation sequence diagram related to a restart of switching control according to Example EX1_4 belonging to the first embodiment of the present disclosure (a case in which charging control of a boot capacitor is performed before the restart of the switching control).

FIG. 15 is an operation sequence diagram related to the restart of switching control according to Example EX1_4 belonging to the first embodiment of the present disclosure (a case in which charging control of a boot capacitor is not performed before the restart of the switching control).

FIG. 16 is an overall configuration diagram of a switching power supply device according to Example EX1_5 belonging to the first embodiment of the present disclosure.

FIG. 17 is a diagram showing a configuration of a monitor circuit according to Example EX2_1 belonging to a second embodiment of the present disclosure.

FIG. 18 is a diagram showing a configuration of a level shifter in FIG. 17.

FIG. 19 is a diagram showing a configuration of a monitor circuit according to Example EX2_2 belonging to the second embodiment of the present disclosure.

FIG. 20 is a diagram showing a configuration of a monitor circuit according to Example EX2_3 belonging to the second embodiment of the present disclosure.

FIG. 21 is a diagram showing a relationship between a detection signal output from a comparator and a protection signal according to Example EX2_3 belonging to the second embodiment of the present disclosure.

FIG. 22 is a timing chart in a vicinity of a start of switching control according to Example EX2_3 belonging to the second embodiment of the present disclosure.

FIG. 23 is another timing chart in the vicinity of the start of switching control according to Example EX2_3 belonging to the second embodiment of the present disclosure.

FIG. 24 is yet another timing chart in the vicinity of the start of switching control according to Example EX2_3 belonging to the second embodiment of the present disclosure.

FIG. 25 is a diagram showing a configuration of a monitor circuit according to Example EX2_4 belonging to the second embodiment of the present disclosure.

FIG. 26 is an operation sequence diagram related to a restart of switching control according to Example EX2_4 belonging to the second embodiment of the present disclosure (a case in which charging control of a boot capacitor is performed before the restart of the switching control).

FIG. 27 is an operation sequence diagram related to the restart of switching control according to Example EX2_4 belonging to the second embodiment of the present disclosure (a case in which charging control of a boot capacitor is not performed before the restart of the switching control).

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

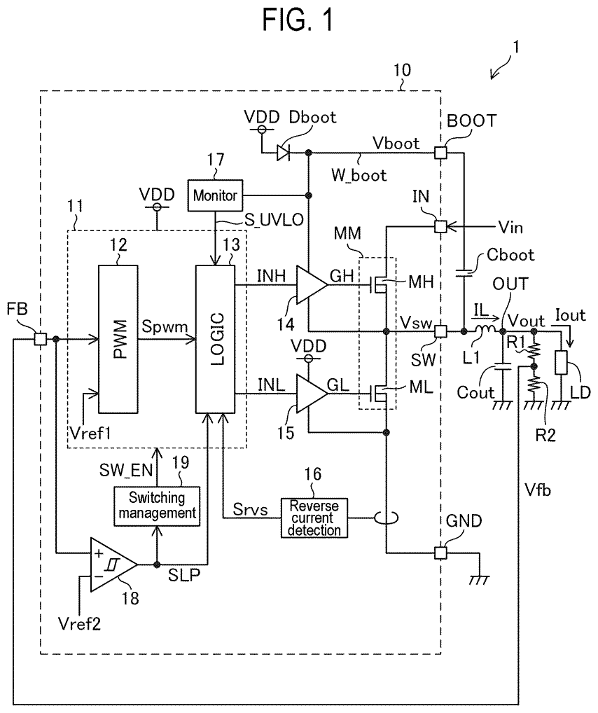

Examples of embodiments of the present disclosure will be specifically described below with reference to the drawings. Throughout the referred drawings, the same parts will be denoted by the same reference numerals, and duplicate explanation thereof may be omitted in principle. In the present disclosure, for the sake of simplification in description, by describing a symbol or a code that refers to information, a signal, a physical quantity, a functional part, a circuit, an element, a part, or the like, the information, the signal, the physical quantity, the functional part, the circuit, the element, the part, or the like, corresponding to the symbol or the code may be omitted or abbreviated. For example, a boot voltage referred to by “Vboot” (see FIG. 1), which will be described later, may be written as a boot voltage Vboot, or may be abbreviated as a voltage Vboot, but they all refer to the same thing.

First, some terms used in the description of the embodiments of the present disclosure will be described. The ground refers to a reference conductor having a reference potential of 0 V (zero volts) or refers to the potential of 0 V itself. The reference conductor may be formed of a conductor such as metal. The potential of 0 V may be referred to as a ground potential. In the embodiments of the present disclosure, a voltage shown without any particular reference represents the potential seen from the ground.

A level refers to a level (height) of potential, and for any signal or voltage of interest, a high level has a higher potential than a low level. For any signal of interest, when the signal of interest has a high level, an inverted signal of the signal of interest has a low level, and when the signal of interest has a low level, the inverted signal of the signal of interest has a high level. For any signal or voltage of interest, a change from a low level to a high level may be referred to as a rising edge, and a change from a high level to a low level may be referred to as a falling edge.

For any transistor configured as a FET (Field Effect Transistor) such as a MOSFET, an on state refers to a state in which the drain and source of the transistor are electrically connected to each other, and an off state refers to a state in which the drain and source of the transistor are electrically disconnected (cut-off state) from each other. The same also applies to transistors that are not classified as FETs. Unless otherwise specified, a MOSFET is regarded as an enhancement type MOSFET. MOSFET is an abbreviation for “metal-oxide-semiconductor field-effect transistor.” Moreover, it may be considered that the back gate is short-circuited to the source in any MOSFET unless otherwise specified. Hereinafter, for any transistor, the on state and the off state may be simply expressed as on and off, respectively. In addition, for any transistor, a period in which the transistor is in an on state is referred to as an on period, and a period in which the transistor is in an off state is referred to as an off period.

For any signal that takes a signal level of a high level or a low level, a period in which the signal level is the high level is referred to as a high-level period, and a period in which the signal level is the low level is referred to as a low-level period. The same applies to any voltage that takes a voltage level of a high level or a low level.

A connection between a plurality of parts forming a circuit, such as arbitrary circuit elements, wirings, and nodes, may be understood to refer to an electrical connection, unless otherwise specified.

When any two voltages to be compared are voltages v1 and v2, “v1>v2” indicates that the voltage v1 is higher than the voltage v2, “v1<v2” indicates that the voltage v1 is lower than the voltage v2, and “v1=v2” indicates that the value of voltage v1 is the same as the value of voltage v2. The same also applies to other equations that include physical quantities other than a voltage.

### First Embodiment

A first embodiment of the present disclosure will be described. FIG. 1 is an overall configuration diagram of a switching power supply device 1 according to the first embodiment. The switching power supply device 1 includes a power supply control device 10 that controls the operation of the switching power supply device 1, and a discrete component group provided outside the power supply control device 10. The discrete component group includes a coil L1, an output capacitor Cout, a boot capacitor Cboot, and feedback resistors R1 and R2. The switching power supply device 1 is configured as a step-down switching power supply device (DC/DC converter) that generates a desired output voltage Vout from an input voltage Vin supplied from the outside. The output voltage Vout is generated at an output terminal OUT. That is, the output terminal OUT is the application terminal of the output voltage Vout (the terminal to which the output voltage Vout is applied). The output voltage Vout is supplied to a load LD connected to the output terminal OUT.

Except in a transient state, the input voltage Vin and the output voltage Vout are positive DC voltages, and the output voltage Vout is lower than the input voltage Vin. For example, when the input voltage Vin is 12 V, the output voltage Vout may be stabilized at a desired target voltage Vtg (for example, 3.3 V or 5 V) less than 12 V by adjusting the resistance values of the feedback resistors R1 and R2. A current supplied to the load LD via the output terminal OUT is referred as a load current Iout. The load current Iout corresponds to an output current of the switching power supply device 1.

The power supply control device 10 is an electronic component that includes a semiconductor chip having a semiconductor integrated circuit formed on a semiconductor substrate, a housing (package) that accommodates the semiconductor chip, and a plurality of external terminals that are exposed to the outside of the power supply control device 10 from the housing. The power supply control device 10 is formed by enclosing the semiconductor chip in the housing (package) made of resin. Each circuit and each element provided in the power supply control device 10 may be included in the semiconductor chip. In FIG. 1, only an input terminal IN, a switch terminal SW, a ground terminal GND, a feedback terminal FB, and a boot terminal BOOT are shown as some of the plurality of external terminals provided in the power supply control device 10, but other external terminals (such as a power good terminal and an enable terminal) may also be provided in the power supply control device 10. The number of external terminals and the type of housing of the power supply control device 10 are optional.

An external configuration of the power supply control device 10 will be described. The input voltage Vin is supplied to the input terminal IN from the outside of the power supply control device 10. The coil L1 is interposed in series between the switch terminal SW and the output terminal OUT. That is, a first end of the coil L1 is connected to the switch terminal SW, and a second end of the coil L1 is connected to the output terminal OUT. The output terminal OUT is connected to the ground via the output capacitor Cout. That is, a first end of the output capacitor Cout is connected to the output terminal OUT, and a second end of the output capacitor Cout is connected to the ground. The output terminal OUT is also connected to a first end of the feedback resistor R1, a second end of the feedback resistor R1 is connected to a first end of the feedback resistor R2, and a second end of the feedback resistor R2 is connected to the ground. A connection node between the feedback resistors R1 and R2 is connected to the feedback terminal FB. First and second ends of the load LD are connected to the output terminal OUT and the ground, respectively. The load LD is an arbitrary load that is driven based on the output voltage Vout. The ground terminal GND is connected to the ground. A first end of the boot capacitor Cboot is connected to the boot terminal BOOT, and a second end of the boot capacitor Cboot is connected to the switch terminal SW. A current flowing through the coil L1 is referred to as a coil current IL. The coil current IL flowing from the switch terminal SW to the output terminal OUT through the coil L1 has a positive polarity, and the coil current IL flowing from the output terminal OUT to the switch terminal SW through the coil L1 has a negative polarity.

An internal configuration of the power supply control device 10 will be described. The power supply control device 10 includes an output stage circuit MM and a control drive block for controlling and driving the output stage circuit MM. The control drive block in the power supply control device 10 includes a switching control circuit 11 having a PWM circuit 12 and a logic circuit 13, a high-side driver 14, a low-side driver 15, a reverse current detection circuit 16, a monitor circuit 17, a light load detection comparator 18, a switching management circuit 19, and a diode Dboot.

The output stage circuit MM includes a transistor MH, which is a high-side transistor, and a transistor ML, which is a low-side transistor. The transistors MH and ML are configured with N-channel MOSFETs. The transistors MH and ML are a pair of switching elements connected in series between the input terminal IN and the ground terminal GND (in other words, the ground). Of these, the transistor MH functions as an output transistor, and the transistor ML functions as a synchronous rectification transistor. The transistor MH is provided on the higher potential side than the transistor ML. Specifically, the drain of the transistor MH is connected to the input terminal IN, which is the application terminal of the input voltage Vin, and receives the input voltage Vin. The source of the transistor MH and the drain of the transistor ML are connected in common to the switch terminal SW. The source of the transistor ML is connected to the ground terminal GND (and therefore connected to the ground). However, a resistor for current detection may be interposed between the source of the transistor ML and the ground terminal GND.

The switching control circuit 11 uses the drivers 14 and 15 to control the switching of the output stage circuit MM. In the switching control of the output stage circuit MM, the transistors MH and ML are switched so that they are alternately turned on and off. The switching control of the output stage circuit MM causes a rectangular-wave switch voltage Vsw to appear at the switch terminal SW. The coil L1 and the output capacitor Cout form a rectifying/smoothing circuit that rectifies and smooths the rectangular-wave switch voltage Vsw appearing at the switch terminal SW to generate the output voltage Vout. The feedback resistors R1 and R2 form a feedback voltage generating circuit that divides the output voltage Vout to generate a feedback voltage Vfb, which corresponds to the output voltage Vout. The feedback voltage Vfb is proportional to the output voltage Vout, and the feedback voltage Vfb also rises and falls as the output voltage Vout rises and falls. The feedback voltage Vfb is input to the feedback terminal FB.

A modification may be made in which the output voltage Vout itself is used as the feedback voltage Vfb. In any case, the feedback voltage Vfb is a voltage corresponding to the output voltage Vout. In addition, the feedback voltage generating circuit (R1, R2) may be provided within the power supply control device 10, in which case the feedback terminal FB is connected to the output terminal OUT.

Although not specifically shown, the power supply control device 10 is provided with an internal power supply circuit that generates one or more internal power supply voltages based on the input voltage Vin. Each circuit within the power supply control device 10 may be driven using the internal power supply voltage or the input voltage Vin as a drive voltage. The one or more internal power supply voltages include a power supply voltage VDD having a predetermined positive DC voltage value. The switching control circuit 11 is driven based on the power supply voltage VDD with the ground potential as a reference. However, there may be a case where the power supply voltage VDD is supplied to the power supply control device 10 from an external voltage source of the power supply control device 10.

Gate signals GH and GL are supplied to the gates of the transistors MH and ML, respectively, as drive signals, and the transistors MH and ML are turned on and off in response to the gate signals GH and GL. The transistor MH is in an on state during a high-level period of the gate signal GH, and is in an off state during a low-level period of the gate signal GH. Similarly, the transistor ML is in an on state during a high-level period of the gate signal GL, and is in an off state during a low-level period of the gate signal GL.

Basically, the transistors MH and ML are alternately turned on and off, but there is also a case where both the transistors MH and ML are maintained in the off state. That is, the state of the output stage circuit MM is one of an output high state, an output low state, and a both off state (Hi-Z state). In the output high state, the transistor MH is in an on state and the transistor ML is in an off state. In the output low state, the transistor MH is in an off state and the transistor ML is in an on state. In the both off state, both the transistors MH and ML are in an off state. The transistors MH and ML are never in an on state at the same time. In the switching control by the switching control circuit 11, turning the transistors MH and ML on and off alternately is a concept that includes the presence of both off state taking into account a dead time, or the like, during the transition between the output low state and the output high state. At least one of the transistors MH and ML may be provided outside the power supply control device 10. The entire output stage circuit MM may be provided outside the power supply control device 10.

The switching control circuit 11 is connected to the feedback terminal FB and receives the feedback voltage Vfb. The switching control circuit 11 cooperates with the drivers 14 and 15 to control the on/off state of each of the transistors MH and ML through the level control of the gate signals GH and GL based on the feedback voltage Vfb, thereby generating the desired output voltage Vout at the output terminal OUT. The switching control circuit 11 adjusts the output duty of the output stage circuit MM by a pulse width modulation method so that the feedback voltage Vfb is equal to a reference voltage Vref1. When “Vfb=Vref1” is established, the value of the output voltage Vout is equal to the value of the target voltage Vtg. The output duty represents a ratio of a period during which the output stage circuit MM is in the output high state to a sum of the period during which the output stage circuit MM is in the output high state and a period during which the output stage circuit MM is in the output low state. The reference voltage Vref1 has a predetermined positive DC voltage value. The power supply control device 10 is provided with a reference voltage generating circuit (not shown) that generates one or more reference voltages based on the input voltage Vin or the power supply voltage VDD. The reference voltage Vref1 and any reference voltages to be described later are generated by the reference voltage generating circuit.

The switching control circuit 11 is provided with the PWM circuit 12 and the logic circuit 13. The feedback voltage Vfb and the reference voltage Vref1 are input to the PWM circuit 12. The PWM circuit 12 generates a control signal Spwm, which is a pulse width modulation signal, and outputs it to the logic circuit 13 so that the feedback voltage Vfb is equal to the reference voltage Vref1 (in other words, so that an error between the feedback voltage Vfb and the reference voltage Vref1 approaches zero). During the period in which the switching control is performed by the switching control circuit 11, the logic circuit 13 outputs drive instruction signals INH and INL according to the control signal Spwm. The drive instruction signal INH from the logic circuit 13 is supplied to the high-side driver 14. The drive instruction signal INL from the logic circuit 13 is supplied to the low-side driver 15.

The high-side driver 14 is connected to a boot wiring W_boot and the gate and source of the transistor MH. The boot wiring W_boot is connected to the boot terminal BOOT. A voltage applied to the boot wiring W_boot and the boot terminal BOOT is referred to as a boot voltage Vboot. The high-side driver 14 drives the gate of the transistor MH by supplying a high-level or low-level gate signal GH to the gate of the transistor MH based on the source potential of the transistor MH (and therefore based on the potential of the switch voltage Vsw), thereby setting the state of the transistor MH to on or off. The boot voltage Vboot and the switch voltage Vsw function as a high-potential-side power supply voltage and a low-potential-side power supply voltage in the high-side driver 14, respectively. The low-side driver 15 is connected to the application terminal of the power supply voltage VDD and the gate and source of the transistor ML. The low-side driver 15 drives the gate of the transistor ML by supplying a high-level or low-level gate signal GL to the gate of the transistor ML based on the source potential of the transistor ML (and therefore based on the ground potential), thereby setting the state of the transistor ML to on or off.

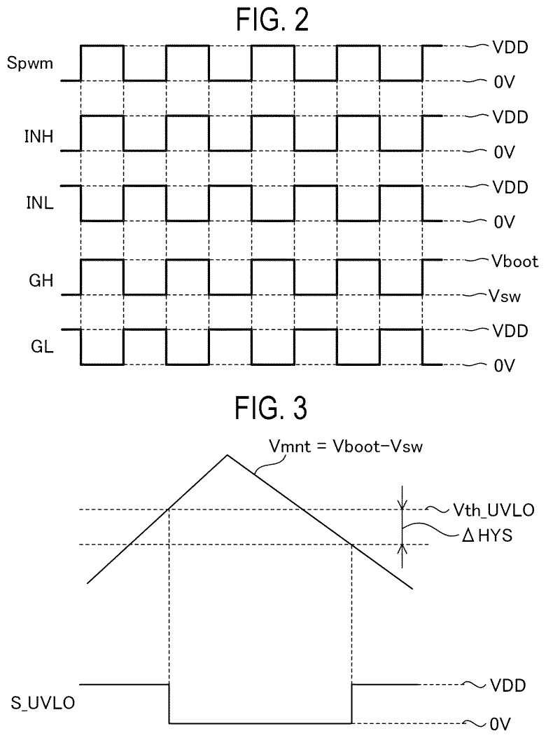

FIG. 2 shows a relationship among the signals Spwm, INH, INL, GH, and GL. The signals Spwm, INH, and INL are binary signals that have either a high level or a low level. In the signals Spwm, INH, and INL, the high level has the potential of the power supply voltage VDD, and the low level has the ground potential. The gate signals GH and GL also have a high level or a low level. The high level of the gate signal GH has the potential of the boot voltage Vboot, and the low level of the gate signal GH has the potential of the switch voltage Vsw. The high level of the gate signal GL has the potential of the power supply voltage VDD, and the low level of the gate signal GL has the ground potential.

When the switching control is performed by the switching control circuit 11, the logic circuit 13 sets the drive instruction signal INH to a high level while setting the drive instruction signal INL to a low level during the high-level period of the control signal Spwm, and sets the drive instruction signal INH to a low level while setting the drive instruction signal INL to a high level during the low-level period of the control signal Spwm. The high-side driver 14 sets the transistor MH to an on state by supplying the high-level gate signal GH to the gate of the transistor MH during the high-level period of the drive instruction signal INH, and sets the transistor MH to an off state by supplying the low-level gate signal GH to the gate of the transistor MH during the low-level period of the drive instruction signal INH. The low-side driver 15 sets the transistor ML to an on state by supplying the high-level gate signal GL to the gate of the transistor ML during the high-level period of the drive instruction signal INL, and sets the transistor ML to an off state by supplying the low-level gate signal GL to the gate of the transistor ML during the low-level period of the drive instruction signal INL.

In practice, when the state of the output stage circuit MM transitions from the output low state to the output high state, the logic circuit 13 adjusts the timing of the level change of the drive instruction signals INH and INL so that the output stage circuit MM transitions to the output high state after passing through the both off state for a small dead time. The same applies when the state of the output stage circuit MM transitions from the output high state to the output low state, but for convenience and simplification of explanation, the existence of the dead time is ignored here. Strictly speaking, after the drive instruction signal INH switches from a low level to a high level, the gate signal GH switches from a low level to a high level over a period of time that depends on the drive capability of the high-side driver 14 and the input capacitance of the transistor GH, but for the sake of simplicity of explanation, the existence of such time is ignored and regarded as being zero. The same applies to the switching of the gate signal GH from the high level to the low level, and to the switching of the gate signal GL between a high level and a low level.

The reverse current detection circuit 16 (see FIG. 1) detects the presence or absence of a reverse current during the on period of the transistor ML and generates a reverse current detection signal Srvs that indicates the detection result. The reverse current detection signal Srvs is supplied to the logic circuit 13. The reverse current is a current that flows from the output terminal OUT to the ground via the coil L1, the switch terminal SW, and the transistor ML, and corresponds to the negative coil current IL. During the execution period of switching control, when the reverse current is detected, the logic circuit 13 switches the transistor ML from on to off to cut off the reverse current, thereby improving efficiency during a light load.

The monitor circuit 17 monitors a level of the boot voltage Vboot seen from the switch voltage Vsw and outputs a protection signal S_UVLO indicating the monitoring result. The protection signal S_UVLO is a low-voltage protection signal related to the boot voltage Vboot. The protection signal S_UVLO from the monitor circuit 17 is input to the logic circuit 13. Hereinafter, the level of the boot voltage Vboot seen from the switch voltage Vsw is referred to as a monitoring target voltage Vmnt. Therefore, “Vmnt=Vboot−Vsw”.

FIG. 3 shows a relationship between the monitoring target voltage Vmnt and the protection signal S_UVLO. The protection signal S_UVLO is a binary signal having a high level or a low level. The high-level protection signal S_UVLO has the potential of the power supply voltage VDD, and the low-level protection signal S_UVLO has the ground potential. A threshold voltage Vth_UVLO and a hysteresis width ΔHYS, each of which has a positive voltage value, are set in advance in the monitor circuit 17. The monitor circuit 17 has a function of comparing the monitoring target voltage Vmnt with the threshold voltage Vth_UVLO. The monitor circuit 17 outputs the high-level protection signal S_UVLO during a period in which “Vmnt<Vth_UVLO−ΔHYS” is established. The voltage (Vth_UVLO−ΔHYS) refers to a voltage that is lower by the hysteresis width ΔHYS than the threshold voltage Vth_UVLO. When the monitoring target voltage Vmnt increases starting from a state in which the protection signal S_UVLO has a high level and the state switches from a state in which “Vmnt<Vth_UVLO” is established to a state in which “Vth_UVLO<Vmnt” or “Vth_UVLO≤Vmnt” is established, the monitor circuit 17 switches the level of the protection signal S_UVLO from a high level to a low level. When the monitoring target voltage Vmnt decreases starting from a state in which the protection signal S_UVLO has a low level and the state switches from a state in which “Vth_UVLO−ΔHYS<Vmnt” is established to a state in which “Vmnt<Vth_UVLO−ΔHYS” or “VmntsVth_UVLO−ΔHYS” is established, the monitor circuit 17 switches the level of the protection signal S_UVLO from a low level to a high level. In this way, it is desirable to provide the monitor circuit 17 with the hysteresis characteristic, but it is also possible to set the hysteresis width ΔHYS to zero. The logic circuit 13 is configured to perform switching control only during the period when the protection signal S_UVLO has a low level, and prohibits switching control during the period when the protection signal S_UVLO is at a high level.

The light load detection comparator 18 (see FIG. 1) is a comparator for detecting a light load state. The light load state corresponds to a state in which the load current Iout is relatively small. The light load detection comparator 18 compares the feedback voltage Vfb input to its non-inverting input terminal with a reference voltage Vref2 input to its inverting input terminal and outputs a sleep signal SLP indicating the comparison result. A hysteresis is set in this comparison. Starting from a state in which the feedback voltage Vfb is lower than the reference voltage Vref2 and the sleep signal SLP is at a low level, the comparator 18 outputs the high-level sleep signal SLP when the feedback voltage Vfb becomes higher than the reference voltage Vref2, and thereafter switches the level of the sleep signal SLP from the high level to a low level when the feedback voltage Vfb becomes lower than a voltage (Vref2−ΔHYS2). The voltage (Vref2−ΔHYS2) is a voltage lower by a positive hysteresis voltage ΔHYS2 than the reference voltage Vref2.

The voltage (Vref2−ΔHYS2) may be higher than the reference voltage Vref1. Thus, the output voltage Vout is stabilized at a predetermined target voltage Vtg when the feedback voltage Vfb is equal to the reference voltage Vref1, so that the sleep signal SLP has a high level only when the output voltage Vout exceeds the target voltage Vtg by a certain amount. However, the reference voltage Vref1 may be equal to the voltage (Vref2-ΔHYS2).

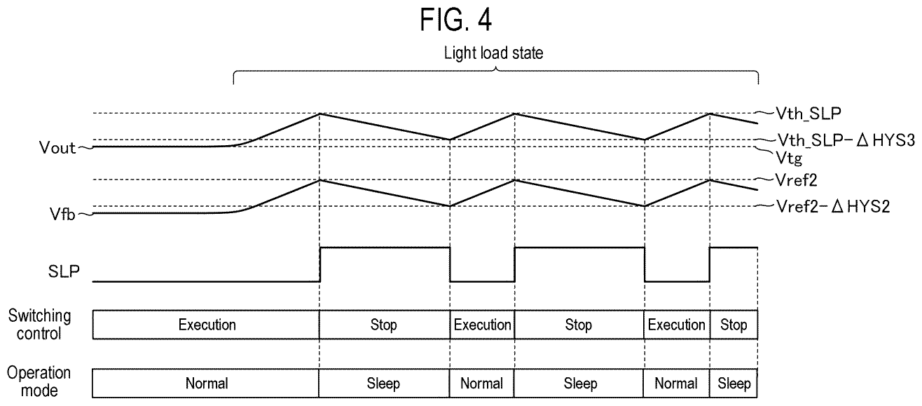

The sleep signal SLP is provided to the logic circuit 13. The logic circuit 13 may set an operation mode of the switching control circuit 11 including itself (hereinafter, simply referred to as an operation mode) to a normal mode or a sleep mode based on the sleep signal SLP, under the assumption that a command signal SW_EN to be described later has a high level. FIG. 4 shows an example of a relationship between the output voltage Vout, the feedback voltage Vfb, the sleep signal SLP, the switching control, and the operation mode. When the output voltage Vout is equal to a predetermined voltage Vth_SLP, the feedback voltage Vfb is equal to the reference voltage Vref2, and when the output voltage Vout is equal to a voltage (Vth_SLP−ΔHYS3), the feedback voltage Vfb is equal to the voltage (Vref2-ΔHYS2). The hysteresis widths ΔHYS2 and ΔHYS3 both have positive predetermined voltage values. The voltage (Vth_SLP−ΔHYS3) represents a voltage lower by the hysteresis width ΔHYS3 than the predetermined voltage Vth_SLP. Here, “Vtg<Vth_SLP−ΔHYS3<Vth_SLP”. However, it may be a case that “Vth_SLP−ΔHYS3=Vtg”.

After the power supply control device 10 is started and the output voltage Vout reaches the target voltage Vtg, switching of the operation mode starting from a state in which the load current Iout is sufficiently large will be described. In a stable state in which the load current out is appropriately large and the output voltage Vout is stabilized at the target voltage Vtg, the sleep signal SLP is at a low level. Under the assumption that the command signal SW_EN to be described later has a high level, the logic circuit 13 sets the operation mode to the normal mode based on the low-level sleep signal SLP in the stable state. In the normal mode, the above-described switching control is executed based on the signal Spwm.

After the transition from the stable state to the light load state, when the switching control is continued based on the low-level sleep signal SLP, the output voltage Vout will rise above the target voltage Vtg and reach the predetermined voltage Vth_SLP, causing a rising edge to occur in the sleep signal SLP. The logic circuit 13 switches the operation mode from the normal mode to the sleep mode at the rising edge of the sleep signal SLP. In the sleep mode, the logic circuit 13 performs sleep control (switching stop control) to stop the switching control. When the switching control is stopped in the sleep mode, both gate signals GH and GL are maintained at a low level, regardless of the control signal Spwm, thereby maintaining both transistors MH and ML in an off state.

After that, when the output voltage Vout falls below the voltage (Vth_SLP−ΔHYS3), a falling edge occurs in the sleep signal SLP. Under the assumption that the command signal SW_EN to be described later has a high level, the logic circuit 13 switches the operation mode from the sleep mode to the normal mode at the falling edge of the sleep signal SLP. At this time, when the light load state is maintained, the switching control is restarted with the switching to the normal mode, but the output voltage Vout reaches the predetermined voltage Vth_SLP in a short time. As a result, while the light load state is maintained, the switching control is repeatedly stopped and restarted, and the output voltage Vout generally goes back and forth between the voltage Vth_SLP and the voltage (Vth_SLP−ΔHYS3). By such control, the switching control is intermittently performed during the light load state, thereby improving the efficiency through a reduction of switching loss. Further, the logic circuit 13 may reduce power consumption by stopping the operation of some circuits in the switching control circuit 11 in the sleep mode.

The switching management circuit 19 (see FIG. 1) supplies the switching control circuit 11 with the command signal SW_EN that commands the execution or stop of the switching control. The command signal SW_EN is a binary signal having a high level or a low level, similar to the sleep signal SLP. The high-level command signal SW_EN functions as an execution command signal that commands the execution of the switching control, and the low-level command signal SW_EN functions as a stop command signal that commands the stop of the switching control. The switching management circuit 19 may generate the command signal SW_EN based on the sleep signal SLP, in which case the command signal SW_EN may be an inverted signal of the sleep signal SLP. Alternatively, the level of the command signal SW_EN may be determined based on an enable signal supplied to the power supply control device 10 from the outside of the power supply control device 10. The enable signal may be an input signal to an enable terminal included in the external terminals of the power supply control device 10. The level of the command signal SW_EN may be determined from a combination of the sleep signal SLP and the enable signal. Further, the level of the command signal SW_EN may be determined based on a command signal supplied to the power supply control device 10 from an external device of the power supply control device 10.

During the low-level period of the command signal SW_EN, the logic circuit 13 maintains the output stage circuit MM in the both off state. The logic circuit 13 may perform switching control of the output stage circuit MM only during the high-level period of the command signal SW_EN. That is, during a period when the command signal SW_EN is at a high level and the sleep signal SLP is at a low level, the PWM circuit 12 generates and outputs the control signal Spwm having a PWM frequency, and the logic circuit 13 performs the switching control of the output stage circuit MM upon receiving the control signal Spwm. Even when the command signal SW_EN is at a high level, during the period when the sleep signal SLP is at a high level, the switching control is stopped and the output stage circuit MM is kept in the both off state, as described with reference to FIG. 4. During the period when the command signal SW_EN is at a low level, the PWM circuit 12 may maintain the control signal Spwm at a low level.

Unless otherwise specified, in the first embodiment and other embodiments to be described later, the sleep signal SLP is assumed to be at a low level.

The anode of the diode Dboot is connected to the application terminal of the power supply voltage VDD and is supplied with the power supply voltage VDD. The cathode of the diode Dboot is connected to the boot wiring W_boot. Therefore, during the on period of the transistor ML, the diode Dboot is conductive, and a charging current is supplied from the application terminal of the power supply voltage VDD to the boot capacitor Cboot through the diode Dboot and the boot terminal BOOT. During the off period of the transistor ML, the diode Dboot is non-conductive. The supply of the charging current to the boot capacitor Cboot increases a voltage across the boot capacitor Cboot. However, the upper limit of the voltage across the boot capacitor Cboot is a voltage (VDD−Vf). Vf represents the forward voltage of the diode Dboot. Due to the installation of a bootstrap circuit including the boot capacitor Cboot and the diode Dboot, during a period in which the switching control is continuously executed, the magnitude of a voltage (Vboot−Vsw) is kept approximately equal to the magnitude of the voltage (VDD−Vf). The voltage (VDD−Vf) is sufficiently larger than the gate threshold voltage of the transistor MH, so that the transistor MH may be driven properly.

The diode Dboot functions as a rectifying element that is conductive during the on period of the transistor ML to supply a charging current to the boot capacitor Cboot with the switch terminal SW set to the low potential side. Instead of the diode Dboot, a switching element formed of a MOSFET may be used as the rectifying element. That is, for example, instead of the diode Dboot, a P-channel MOSFET having a drain connected to the application terminal of the power supply voltage VDD and a source connected to the boot wiring W_boot may be provided as the rectifying element. In this case, the logic circuit 13 may control the on/off of the MOSFET so that the MOSFET as the rectifying element is on only during the on period of the transistor ML.

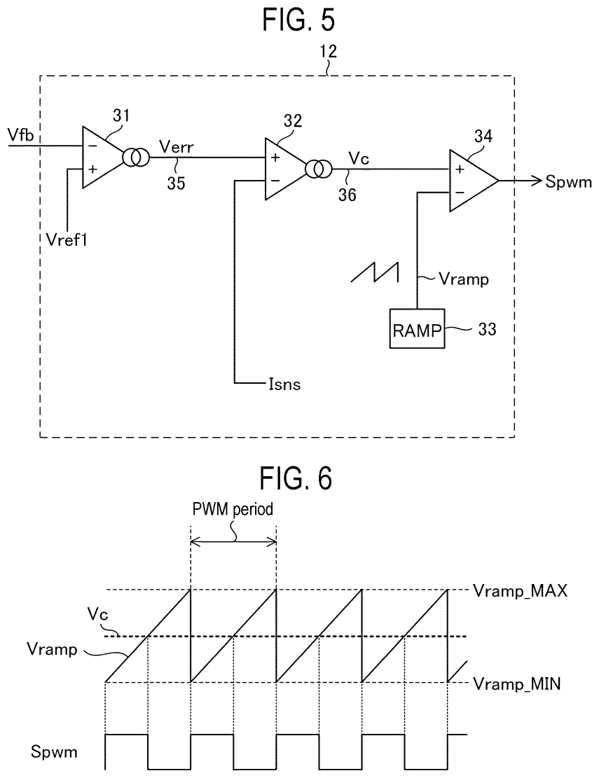

FIG. 5 shows a schematic configuration example of the PWM circuit 12. The PWM circuit 12 of FIG. 5 includes, as its main components, an error amplifier 31, a differential amplifier 32, a ramp voltage generating circuit 33, and a comparator (PWM comparator) 34. The error amplifier 31 and the differential amplifier 32 are current output type transconductance amplifiers.

An inverting input terminal of the error amplifier 31 is connected to the feedback terminal FB and receives the feedback voltage Vfb. A predetermined reference voltage Vref1 is supplied to a non-inverting input terminal of the error amplifier 31. The error amplifier 31 generates an error voltage Verr according to a difference between the feedback voltage Vfb and the reference voltage Vref1 on a wiring 35. When “Vfb<Vref1” is established, the error amplifier 31 outputs a current from its output terminal toward the wiring 35 to increase the error voltage Verr, and when “Vfb>Vref1” is established, it draws a current from the wiring 35 toward its output terminal to decrease the error voltage Verr. Although not shown particularly, a phase compensation circuit that compensates for the phase of the error voltage Verr is provided between the wiring 35 and the ground.

The coil current IL is detected by a current sensor (not shown) provided in the power supply control device 10, and a current detection signal Isns indicating a value of the coil current IL is generated. Since the current detection signal Isns is a voltage signal, a voltage represented by the current detection signal Isns may be referred to as a voltage Isns. For example, the current sensor has a sense resistor provided between the source of the transistor ML and the ground terminal GND and generates the voltage Isns by sampling a voltage drop of the sense resistor during the on period of the transistor ML. That is, the coil current IL may be detected by detecting a current flowing through the transistor ML. However, the current sensor may generate the voltage Isns by detecting the current flowing through the transistor MH or by directly detecting the current flowing through the coil L1.

The differential amplifier 32 has an inverting input terminal, a non-inverting input terminal, and an output terminal. The output terminal of the differential amplifier 32 is connected to a wiring 36. The non-inverting input terminal of the differential amplifier 32 is connected to the wiring 35 and is supplied with the error voltage Verr, and the inverting input terminal of the differential amplifier 32 is supplied with the voltage Isns. The differential amplifier 32 generates a comparison voltage Vc according to a difference between the error voltage Verr and the voltage Isns on the wiring 36. When “Isns<Verr” is established, the differential amplifier 32 outputs a current from its output terminal toward the wiring 36 to increase the comparison voltage Vc, and when “Isns>Verr” is established, it draws a current from the wiring 36 toward its output terminal to decrease the comparison voltage Vc. Although not shown particularly, a phase compensation circuit that compensates for the phase of the comparison voltage Vc is provided between the wiring 36 and the ground.

The ramp voltage generating circuit 33 generates a ramp voltage Vramp whose voltage value changes periodically at a predetermined PWM period. The PWM period corresponds to the inverse of the PWM frequency. The ramp voltage Vramp has, for example, a triangular or sawtooth voltage waveform. The period of fluctuation of the ramp voltage Vramp is the PWM period. Here, as shown in FIG. 6, in each PWM period, the ramp voltage Vramp increases monotonically linearly over time starting from the lower limit voltage value Vramp_MIN, and when it reaches the upper limit voltage value Vramp_MAX, it instantly returns to the lower limit voltage value Vramp_MIN. “Vramp_MIN<Vramp_MAX” is established.

The non-inverting input terminal of the comparator 34 is connected to the wiring 36 and is supplied with the comparison voltage Vc. The inverting input terminal of the comparator 34 is supplied with the ramp voltage Vramp. The comparator 34 compares the comparison voltage Vc with the ramp voltage Vramp and outputs the control signal Spwm indicating the comparison result. The control signal Spwm has a high level during a period when the comparison voltage Vc is higher than the ramp voltage Vramp, and has a low level during a period when the comparison voltage Vc is lower than the ramp voltage Vramp.

The power supply control device 10 including the PWM circuit 12 of FIG. 5 employs a current mode control method that performs output feedback control based on both the output voltage Vout and the coil current IL. The voltage Isns according to the coil current IL is fed back to the differential amplifier 32, and due to the action of the differential amplifier 32, when the error voltage Verr rises, the coil current IL increases, and when the error voltage Verr drops, the coil current IL decreases. The circuit configuration of FIG. 5 is merely an example, and various control methods (for example, a voltage mode control method, a pulse frequency modulation method, and a constant on-time control method) may be adopted in the power supply control device 10.

By installing the above-described bootstrap circuit, the magnitude of the voltage (Vboot−Vsw) is kept approximately equal to the magnitude of the power supply voltage VDD during the period in which switching control is continuously performed. However, in the switching power supply device 1, the output stage circuit MM may be in the both off state for a relatively long time. When the degree of decrease in the boot voltage Vboot increases due to the progress of discharge of the boot capacitor Cboot during a period in which the output stage circuit MM is in the both off state, the transistor MH may not be driven properly. The decrease in the boot voltage Vboot causes a decrease in the operating speed of the high-side driver 14, and the decrease in the operating speed of the high-side driver 14 may cause a through current to occur due to the simultaneous turn-on of the transistors MH and ML through a delay in turn-off of the transistor MH.

As a countermeasure against this, the monitor circuit 17 has a function of checking whether or not the boot capacitor Cboot is charged to a required degree. That is, when starting the switching control, the logic circuit 13 sets the output stage circuit MM to an output low state before starting the switching control, and waits to execute switching control until the monitor circuit 17 outputs a signal indicating that the monitoring target voltage Vmnt corresponding to the voltage (Vboot-Vsw) has reached the threshold voltage Vth_UVLO, that is, the low-level protection signal S_UVLO. Then, after receiving the low-level protection signal S_UVLO from the monitor circuit 17, the logic circuit 13 starts the switching control.

The first embodiment includes the following Examples EX1_1 to EX1_5. In Examples EX1_1 to EX1_5, detailed configuration examples and operation examples related to the operation based on the monitoring target voltage Vmnt will be described. The matters described above in the first embodiment apply to the following Examples EX1_1 to EX1_5 unless otherwise stated and unless contradictory. However, in each Example, for matters that contradict the matters described above in the first embodiment, the description in each Example may take precedence. In addition, the matters described in any of Examples EX1_1 to EX1_5 may be applied to any other Examples (that is, it is also possible to combine any two or more Examples among the plurality of Examples) to the extent that they are not contradictory.

### Example EX1_1

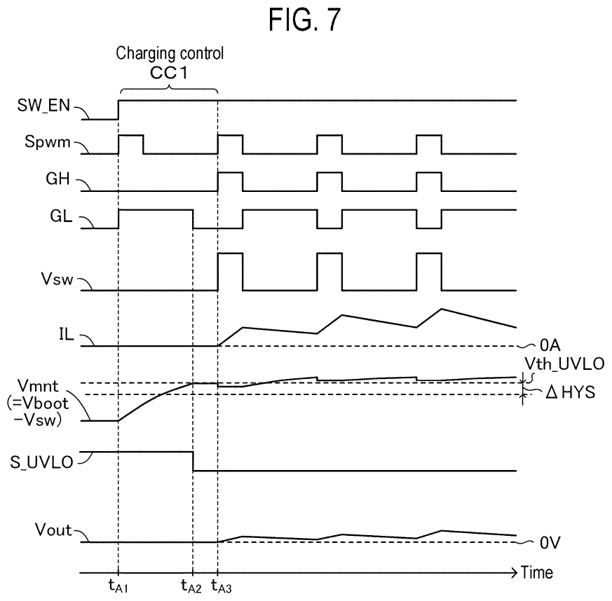

Example EX1_1 will be described. FIG. 7 shows a timing chart in a vicinity of a start of switching control according to Example EX1_1. FIG. 7 shows, from top to bottom, waveforms of the command signal SW_EN, the control signal Spwm, the gate signal GH, the gate signal GL, the switch voltage Vsw, the coil current IL, the monitoring target voltage Vmnt, the protection signal S_UVLO, and the output voltage Vout. As time progresses, times t_{A1}, t_{A2}, and t_{A3} occur in this order. Before time t_{A1}, the command signal SW_EN is maintained at a low level for a long time. Just before time tai, the coil current IL is 0 A (zero amperes), the output voltage Vout is 0 V (zero volts), and the monitoring target voltage Vmnt is sufficiently low, so that the protection signal S_UVLO has a high level. The switching control circuit 11 according to Example EX_1 executes charging control CC1 as control for charging the boot capacitor Cboot. The significance of the charging control CC1 will become clear in comparison with charging control CC2 of Example EX1_2 to be described later.

At time t_{A1}, a rising edge occurs in the command signal SW_EN. In response to the rising edge of the command signal SW_EN, the PWM circuit 12 starts generating and outputting the control signal Spwm having a PWM frequency. In the example of FIG. 7, a rising edge occurs in the control signal Spwm at time t_{A1}. The logic circuit 13 according to Example EX1_1 responds to the rising edge of the command signal SW_EN and switches the output stage circuit MM from the both off state to the output low state at time t_{A1}. When the output stage circuit MM is in the output low state, the monitoring target voltage Vmnt rises due to charging of the boot capacitor Cboot, and when the monitoring target voltage Vmnt reaches the threshold voltage Vth_UVLO at time t_{A2}, a falling edge occurs in the protection signal S_UVLO. Note that the monitoring target voltage Vmnt reaching the threshold voltage Vth_UVLO refers to a transition from a state where “Vmnt<Vth_UVLO” is established to a state where “Vmnt>Vth_UVLO” or “Vmnt≥Vth_UVLO” is established.

Upon receiving the falling edge of the protection signal S_UVLO, the logic circuit 13 enters a state permitting the execution of switching control (in other words, a state permitting the output stage circuit MM to be set to the output high state), and thereafter executes the switching control for the output stage circuit MM in response to the control signal Spwm having the PWM frequency. In the example of FIG. 7, the control signal Spwm has a low level at time t_{A2}, and the next rising edge of the control signal Spwm occurs at time t_{A3}. Therefore, in response to the falling edge of the protection signal S_UVLO, the logic circuit 13 switches the output stage circuit MM from the output low state to the both off state at time t_{A2}, then switches the output stage circuit MM from the both off state to the output high state at the rising edge of the control signal Spwm at time t_{A3}, and thereafter continues to execute the switching control according to the control signal Spwm.

When the logic circuit 13 according to Example EX1_1 receives the rising edge of the command signal SW_EN, it keeps the output stage circuit MM in the output low state until the falling edge occurs in the protection signal S_UVLO, regardless of whether a reverse current occurs (and therefore regardless of the reverse current detection signal Srvs). For this reason, when the rising edge occurs in the command signal SW_EN in a state where the output voltage Vout has a relatively high voltage, a relatively large negative coil current IL may be generated.

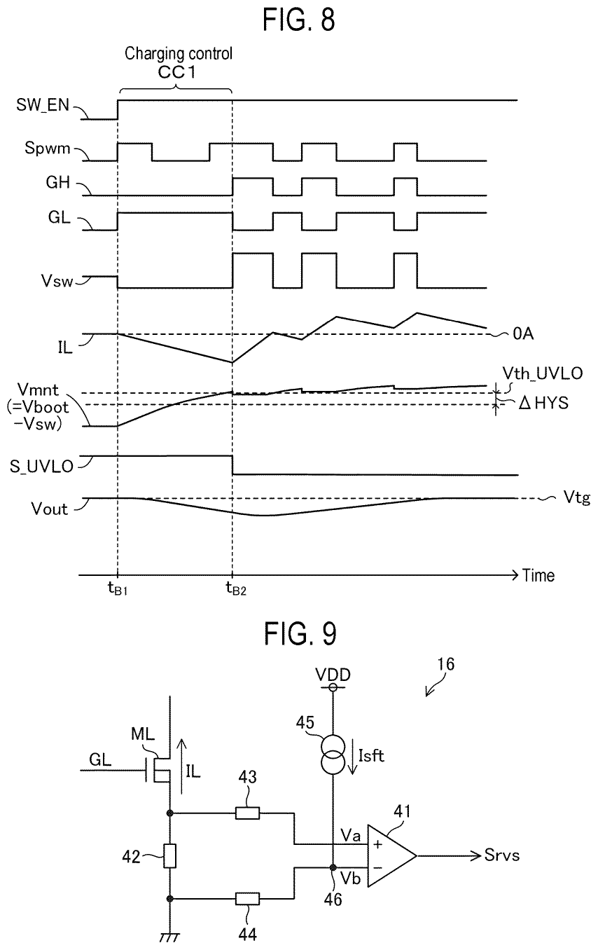

FIG. 8 shows another timing chart in the vicinity of the start of switching control according to Example EX1_1. FIG. 8 shows, from top to bottom, waveforms of the command signal SW_EN, the control signal Spwm, the gate signal GH, the gate signal GL, the switch voltage Vsw, the coil current IL, the monitoring target voltage Vmnt, the protection signal S_UVLO, and the output voltage Vout. As time progresses, times t_{B1} and t_{B2} occur in this order. After the switching control is performed, when the operation mode of the switching control circuit 11 is set to the sleep mode, the command signal SW_EN is maintained at a low level for a certain period of time, and thereafter time t_{B1} is reached. Just before time t_{B1}, the coil current IL is 0 A (zero amperes). In addition, just before time t_{B1}, the monitoring output voltage Vmnt is sufficiently low, so that the protection signal S_UVLO has a high level, but the output voltage Vout has a positive voltage close to the target voltage Vtg.

At time t_{B1}, a rising edge occurs in the command signal SW_EN. In response to the rising edge of the command signal SW_EN, the PWM circuit 12 starts generating and outputting the control signal Spwm having a PWM frequency. In the example of FIG. 8, a rising edge occurs in the control signal Spwm at time t_{B1}. The logic circuit 13 according to Example EX1_1 responds to the rising edge of the command signal SW_EN and switches the output stage circuit MM from the both off state to the output low state at time t_{B1}. When the output stage circuit MM is in the output low state, the monitoring target voltage Vmnt rises due to charging of the boot capacitor Cboot, and when the monitoring target voltage Vmnt reaches the threshold voltage Vth_UVLO at time t_{B2}, the falling edge is generated in the protection signal S_UVLO.

Upon receiving the falling edge of the protection signal S_UVLO, the logic circuit 13 enters a state permitting the execution of switching control (in other words, a state permitting the output stage circuit MM to be set to the output high state), and thereafter executes the switching control for the output stage circuit MM in response to the control signal Spwm having a PWM frequency. In the example of FIG. 8, since the control signal Spwm has a high level at time t_{B2}, the logic circuit 13 switches the output stage circuit MM from the output low state to the output high state in accordance with the control signal Spwm at time t_{B2}. That is, the logic circuit 13 restarts the switching control for the output stage circuit MM from time t_{B2} and thereafter continues to execute the switching control.

In the example of FIG. 8, the output stage circuit MM is maintained in the output low state until the monitoring target voltage Vmnt reaches the threshold voltage Vth_UVLO from time t_{B1} (that is, until time t_{B2}), so that a relatively large negative coil current IL is generated. The coil current IL with an excessively large absolute value is not desirable for protecting the transistor ML. In addition, an excessive decrease in the output voltage Vout due to the large negative coil current IL may adversely affect the normal operation of the load LD.

The logic circuit 13 according to Example EX1_1 may set the output stage circuit MM to the output low state for a certain period of time (for example, 2 microseconds) at the rising edge of the command signal SW_EN, and thereafter may perform the switching control in response to the control signal Spwm. In this case, the certain period of time is determined in advance so that the output low state of the output stage circuit MM triggered by the rising edge of the command signal SW_EN is expected to allow the monitoring target voltage Vmnt to reach the threshold voltage Vth_UVLO with a time margin to spare. This method may also result in a large negative coil current IL and an excessive decrease in the output voltage Vout.

### Example EX1_2

Example EX1_2 will be described. In Example EX1_2, the reverse current detection circuit 16 is used to suppress an excessive negative coil current IL during the period until the monitoring target voltage Vmnt reaches the threshold voltage Vth_UVLO.

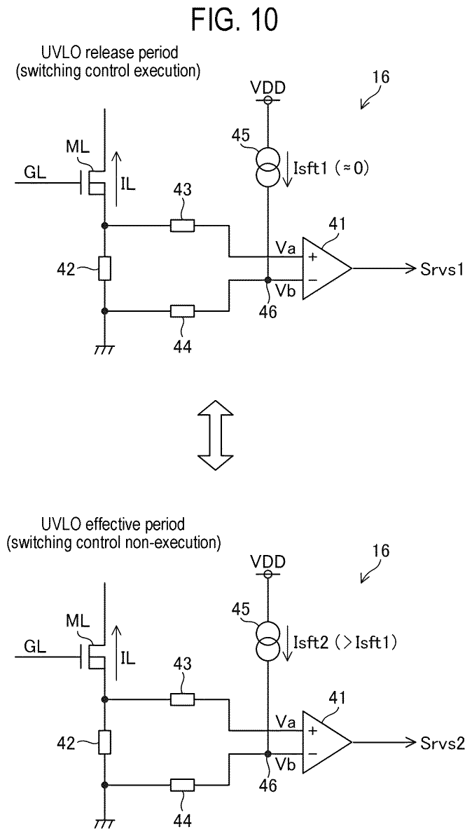

FIG. 9 shows a configuration of the reverse current detection circuit 16. The reverse current detection circuit 16 of FIG. 9 includes a comparator 41, resistors 42 to 44, and a current source 45. The resistor 42 is a sense resistor for detecting a current flowing through the transistor ML during the on period of the transistor ML, that is, the coil current IL. Note that FIG. 9 shows, as an example, a situation in which the polarity of the coil current IL is positive (the same applies to FIG. 10 to be described later). A first end of the sense resistor 42 is connected to the source of the transistor ML, and a second end of the sense resistor 42 is connected to the ground. A first end of the resistor 43 is connected to the first end of the sense resistor 42, and a second end of the resistor 43 is connected to the non-inverting input terminal of the comparator 41. A first end of the resistor 44 is connected to the second end of the sense resistor 42 (and therefore connected to the ground in the configuration of FIG. 9), and a second end of the resistor 44 is connected to a node 46 and to the inverting input terminal of the comparator 41. The resistors 43 and 44 have the same resistance value. The current source 45 is interposed between the application end of the power supply voltage VDD and the node 46 and is configured to be able to supply a specified shift current Isft from the application end of the power supply voltage VDD to the node 46.

Under the control of the logic circuit 13, the current source 45 is configured so that the shift current Isft may be switched between a shift current Isft1 and a shift current Isft2 (see FIG. 10). Here, the shift current Isft2 is larger than the shift current Isft1. The shift current Isft1 may be zero or may have a minute current value close to zero. When the shift current Isft1 is zero, a switch may be provided between the current source 45 and the node 46, and the shift current Isht from the current source 45 to the node 46 may be switched between the shift current Isft2 and zero by controlling the on/off of the switch.

During the on period of the transistor ML, a voltage drop according to the magnitude and polarity of the coil IL occurs across the sense resistor 42. A voltage at the non-inverting input terminal of the comparator 41 is referred to as a voltage Va, and a voltage at the inverting input terminal of the comparator 41 is referred to as a voltage Vb. The comparator 41 compares the voltages Va and Vb, outputs a high-level reverse current detection signal Srvs when “Va>Vb” is established, and outputs a low-level reverse current detection signal Srvs when “Va<Vb” is established. When “Va=Vb” is established, the reverse current detection signal Srvs has a high level or a low level. The reverse current detection signal Srvs has significant information only during the on period of the transistor ML, and the reverse current detection signal Srvs is invalid during the off period of the transistor ML.

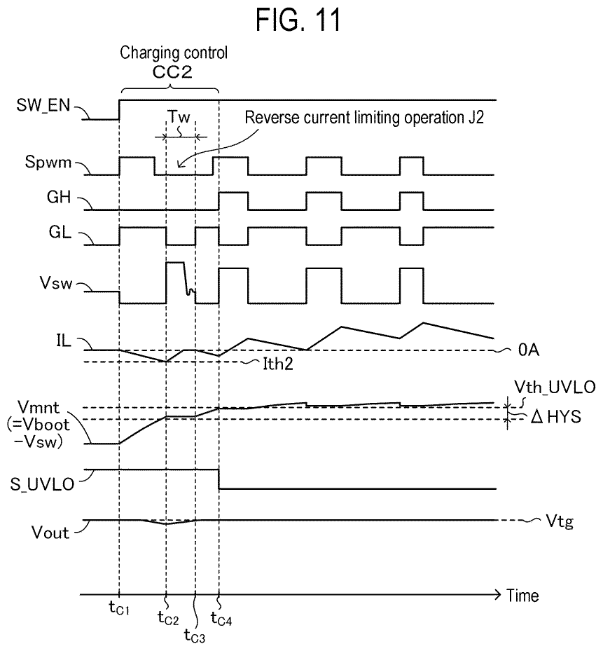

Referring to FIG. 10, the logic circuit 13 sets the shift current Isft1 to the shift current Isft during a UVLO release period related to the boot voltage Vboot, and sets the shift current Isft2 to the shift current Isft during a UVLO effective period related to the boot voltage Vboot. The UVLO effective period is a period during which the monitoring target voltage Vmnt has not reached the threshold voltage Vth_UVLO and therefore the protection signal S_UVLO has a high level. The UVLO release period is a period during which the monitoring target voltage Vmnt is maintained at or above the voltage (Vth_UVLO-ΔHYS) after the monitoring target voltage Vmnt rises to or above the threshold voltage Vth_UVLO. The reverse current detection signal Srvs during the UVLO release period is specifically referred to as a reverse current detection signal Srvs1, and the reverse current detection signal Srvs during the UVLO effective period is specifically referred to as a reverse current detection signal Srvs2. In the example of FIG. 11 to be described later, a period from time t_{C1} to just before time t_{C4} belongs to the UVLO effective period, and a period after time t_{C4} belongs to the UVLO release period. The switching control is not performed during the UVLO effective period, and the switching control is performed only during the UVLO release period.

During the on period of the transistor ML, the comparator 41 outputs the high-level reverse current detection signal Srvs when the coil current IL has negative polarity and the magnitude (absolute value) of the coil current IL is equal to or greater than a current threshold value Ith. During the on period of the transistor ML, the comparator 41 outputs the low-level reverse current detection signal Srvs when the coil current IL has positive polarity, when the coil current IL is zero, or when the coil current IL has negative polarity but the magnitude (absolute value) of the coil current IL is less than a current threshold value Ith_rvs. The current threshold value Ith is also switched by switching the shift current Isft between the shift currents Isft1 and Isft2. The current threshold value Ith during the UVLO release period, that is, a period when “Isft=Isht1,” is the current threshold value Ith1. The current threshold value Ith during the UVLO effective period, that is, a period when “Isft=Isht2,” is the current threshold value Ith2. The current threshold values Ith1 and Ith2 have positive values, and the current threshold value Ith2 is greater than the current threshold value Ith1. By making “Isft2>Isft1,” “Ith2>Ith1” is implemented.

During a period that belongs to the UVLO release period and in which the switching control of the output stage circuit MM is performed according to the control signal Spwm, the logic circuit 13 monitors the level of the reverse current detection signal Srvs1 and executes a reverse current prevention operation J1 when a rising edge of the reverse current detection signal Srvs1 occurs while the transistor ML is set to on. In the reverse current prevention operation J1, the logic circuit 13 immediately switches the state of the output stage circuit MM from the output low state to the both off state, regardless of the level of the control signal Spwm. After the reverse current prevention operation J1 is performed, when a rising edge occurs in the control signal Spwm, the logic circuit 13 switches the state of the output stage circuit MM from the both off state to the output high state. The reverse current prevention operation J1 may improve efficiency during the light load.

On the other hand, during the UVLO effective period, the logic circuit 13 monitors the level of the reverse current detection signal Srvs2 and executes a reverse current limiting operation J2 when a rising edge of the reverse current detection signal Srvs2 occurs when the transistor ML is set to on (that is, when the output stage circuit MM is set to the output low state). In the reverse current limiting operation J2, the logic circuit 13 switches the state of the output stage circuit MM from the output low state to the both off state, and then maintains the output stage circuit MM in the both off state for a predetermined waiting time Tw (for example, 50 nanoseconds) before returning it to the output low state. This makes it possible to suppress an excessively negative coil current IL when charging the boot capacitor Cboot.

FIG. 11 shows a timing chart in a vicinity of a start of switching control according to Example EX1_2. FIG. 11 shows, from top to bottom, waveforms of the command signal SW_EN, the control signal Spwm, the gate signal GH, the gate signal GL, the switch voltage Vsw, the coil current IL, the monitoring target voltage Vmnt, the protection signal S_UVLO, and the output voltage Vout. As time progresses, times t_{C1}, t_{C2}, t_{C3}, and t_{C4} occur in this order. As already mentioned, the period from time ter to just before time t_{C4} belongs to the UVLO effective period, and the period after time t_{C4} belongs to the UVLO release period (see FIG. 10 as appropriate).

After the switching control is executed, when the operation mode of the switching control circuit 11 is set to the sleep mode, the command signal SW_EN is maintained at a low level for a certain period of time, and thereafter time ter is reached. Just before time t_{C1}, the coil current IL is 0 A (zero amperes). In addition, just before time t_{C1}, the monitoring output voltage Vmnt is sufficiently low so that the protection signal S_UVLO has a high level, but the output voltage Vout has a positive voltage close to the target voltage Vtg.

At time t_{C1}, a rising edge occurs in the command signal SW_EN. In response to the rising edge of the command signal SW_EN, the PWM circuit 12 starts generating and outputting the control signal Spwm having a PWM frequency. In the example of FIG. 11, a rising edge occurs in the control signal Spwm at time ter. The logic circuit 13 according to Example EX1_2 responds to the rising edge of the command signal SW_EN and switches the output stage circuit MM from the both off state to the output low state at time ter. When the output stage circuit MM is in the output low state, the monitoring target voltage Vmnt rises due to charging of the boot capacitor Cboot. On the other hand, when the output voltage Vout is relatively high, the transistor ML is turned on, thereby generating a negative coil current IL and increasing the magnitude (absolute value) of the coil current IL from time t_{C1}.

At time t_{C2} before the monitoring target voltage Vmnt reaches the threshold voltage Vth_UVLO, with the transistor ML set to on, the reverse current detection circuit 16 detects a specific reverse current state. The specific reverse current state is a state in which the coil current IL has a negative polarity and the magnitude (absolute value) of the coil current IL is equal to or greater than the current threshold value Ith2. The occurrence of a rising edge in the reverse current detection signal Srvs2 during the UVLO effective period corresponds to the detection of the specific reverse current state (detection that the specific reverse current state exists). Therefore, a rising edge occurs in the reverse current detection signal Srvs2 (see FIG. 10) at time t_{C2}. When the logic circuit 13 detects the specific reverse current state before the monitoring target voltage Vmnt reaches the threshold voltage Vth_UVLO with the output stage circuit MM set to the output low state (that is, when the rising edge occurs in the reverse current detection signal Srvs2), it executes the above-described reverse current limiting operation J2. Therefore, the logic circuit 13 switches the state of the output stage circuit MM from the output low state to the both off state at time t_{C2}, and then maintains the state of the output stage circuit MM in the both off state for a predetermined waiting time Tw before returning it to the output low state. The time when the state of the output stage circuit MM is returned to the output low state is time t_{C3}. Therefore, a time difference between times t_{C2} and tea corresponds to the waiting time Tw.

When the state of the output stage circuit MM is returned to the output low state at time t_{C3}, the charging of the boot capacitor Cboot is restarted and the rising of the monitoring target voltage Vmnt is restarted. In the example of FIG. 11, after time t_{C3}, the specific reverse current state is not detected again, and at time t_{C4}, the monitoring target voltage Vmnt reaches the threshold voltage Vth_UVLO, causing a falling edge to occur in the protection signal S_UVLO. Upon receiving the falling edge of the protection signal S_UVLO, the logic circuit 13 enters a state permitting the execution of switching control (in other words, a state permitting the output stage circuit MM to be set to the output high state) and starts the switching control for the output stage circuit MM based on the control signal Spwm, which is a signal generated according to the feedback voltage Vfb and has a PWM frequency. That is, the logic circuit 13 restarts the switching control for the output stage circuit MM from time t_{C4}, and thereafter continues to execute the switching control. In the example of FIG. 11, since the control signal Spwm has a high level at time t_{C4}, the logic circuit 13 switches the output stage circuit MM from the output low state to the output high state according to the control signal Spwm at time t_{C4}.

In the example of FIG. 11, the magnitude of the coil current IL decreases toward zero due to the reverse current limiting operation J2 that is performed starting from time t_{C2}. Note that in the timing chart of FIG. 11, in the first half of a period between times t_{C2} and t_{C3}, the negative coil current IL flows through a parasitic diode of the transistor MH, causing the switch voltage Vsw to become equal to the sum of the input voltage Vin and the forward voltage of the parasitic diode, and then in the second half of the period between times t_{C2} and t_{C3}, “IL=0” is reached, causing the switch voltage Vsw to resonate near the output voltage Vout. After the detection of the specific reverse current state, when the transistor ML is turned on again after a certain period of time (Tw), the magnitude of the coil current IL begins to increase again from 0 A. In this way, the magnitude of the negative coil current IL is limited by the reverse current limiting operation J2, so that the negative coil current IL does not become excessive. In addition, during the UVLO effective period, the charges equivalent to the time integration of the coil current IL are drawn from the output capacitor Cout. However, in Example EX1_2 (FIG. 11), the coil current IL related to the reverse current is smaller than that in Example EX1_1 (FIG. 8), so that the amount of decrease in the output voltage Vout may be suppressed to a small amount. For example, when the magnitude of the negative coil current IL increases to 3 A in Example EX1_1 (FIG. 8), the current threshold value Ith2 is set to 300 mA in Example EX1_2 (FIG. 11). So then, in Example EX1_2, the amount of decrease in the output voltage Vout may be suppressed to 1/10 as compared to Example EX1_1.

When the specific reverse current state is detected again after time t_{C3} and before the monitoring target voltage Vmnt reaches the threshold voltage Vth_UVLO, the logic circuit 13 executes the second reverse current limiting operation J2. That is, when the specific reverse current state is detected again after time t_{C3} and before the monitoring target voltage Vmnt reaches the threshold voltage Vth_UVLO, the logic circuit 13 switches the state of the output stage circuit MM from the output low state back to the both off state, and then maintains the state of the output stage circuit MM in the both off state for a predetermined waiting time Tw before returning it to the output low state again. The same applies to the third and subsequent reverse current limiting operations J2, and the magnitude of the coil current IL is returned to zero each time the reverse current limiting operation J2 is performed.

In addition, although it is different from the situation shown in FIG. 11, when there is no occasion to detect a specific reverse current state even once after time t_{C1} and the monitoring target voltage Vmnt rises to the threshold voltage Vth_UVLO, causing a falling edge in the protection signal S_UVLO, the logic circuit 13 starts the switching control of the output stage circuit MM based on the control signal Spwm without an occasion to perform the reverse current limiting operation J2 even once.

In this way, when the switching control circuit 11 receives the rising edge of the command signal SW_EN, it sets the output stage circuit MM to the output low state in the state where “Vmnt<Vth_UVLO” is established, and then maintains the output stage circuit MM in the output low state until the monitoring target voltage Vmnt rises and reaches the threshold voltage Vth_UVLO or the specific reverse current state is detected. When the specific reverse current state is detected before the monitoring target voltage Vmnt reaches the threshold voltage Vth_UVLO with the output stage circuit MM set to the output low state, the switching control circuit 11 executes the reverse current limiting operation J2 that switches the state of the output stage circuit MM from the output low state to the both off state and keeps the output stage circuit MM in the both off state for a predetermined waiting time Tw before returning it to the output low state. Then, the switching control circuit 11 permits the output stage circuit MM to be set to the output high state when the monitoring target voltage Vmnt reaches the threshold voltage Vth_UVLO. Therefore, after the monitoring target voltage Vmnt reaches the threshold voltage Vth_UVLO, the switching control based on the control signal Spwm is started. The start of the switching control may be the restart of the switching control.

By using this method, it is possible to suppress the generation of a large coil current IL having a negative polarity when charging the boot capacitor Cboot. Since the large coil current IL is suppressed from flowing through the transistor ML, the transistor ML is protected. In addition, an excessive decrease in the output voltage Vout due to the large negative coil current IL is suppressed, and the adverse effect on the load LD due to the decrease in the output voltage Vout is also suppressed.

The execution period of the switching control belongs to the UVLO release period. During the execution period of the switching control, the reverse current detection circuit 16 may detect a reverse current state (hereinafter, referred to as a first reverse current state) in which the magnitude of the reverse current (negative coil current IL) exceeds the current threshold th1. The switching control circuit 11 sets the output stage circuit MM to the output low state based on the control signal Spwm during the execution period of the switching control, and then executes the reverse current prevention operation J1 to switch the output stage circuit MM from the output low state to the both off state regardless of the control signal Spwm when the first reverse current state is detected by the reverse current detection circuit 16. The reverse current detection circuit 16 may detect a reverse current state (hereinafter, referred to as a second reverse current state) in which the magnitude of the reverse current (negative coil current IL) exceeds the current threshold value Ith2, as a specific reverse current state, using the same circuit as the circuit for detecting the first reverse current state. As described above, “Ith1<Ith2” is established.

The reverse current prevention operation J1 associated with the detection of the first reverse current state improves efficiency during a light load. By using the same circuit as the reverse current detection circuit 16 provided for improving efficiency during the light load and shifting the current threshold value, the specific reverse current state (the second reverse current state) may be detected when charging the boot capacitor Cboot. Therefore, the number of circuits to be added to realize the reverse current limiting operation J2 is very small (the increase in chip cost is only slight).

In order to improve efficiency during the light load, it is better to set the current threshold value Ith1 for detecting the first reverse current state to be close to zero as much as possible. On the other hand, when a current threshold close to zero is used as the current threshold value Ith2 during the UVLO effective period, since the magnitude (absolute value) of the negative coil current IL reaches the current threshold value Ith2 immediately after turning on the transistor ML, charging of the boot capacitor Cboot does not proceed quickly. For this reason, the current threshold value Ith2 is shifted in the increasing direction from the current threshold value Ith1. The current threshold value may be shifted by supplying a necessary current to the resistor 44 using the current source 45 (see FIG. 9 and FIG. 10). For example, when the values of the resistors 42 and 44 are set to 10 mΩ and 1 kΩ, respectively, and the value of the shift current Isht2 is set to 3 μA, the current threshold value Ith2 becomes 300 mA. Although the value of the resistor 43 does not affect the current threshold value (Ith1, Ith2), it is preferable to provide the resistor 43 having the same resistance as the resistor 44 in order to match the impedance of a differential signal (signal of voltages Va and Vb) input to the comparator 41. However, it is also possible to omit the resistor 43.

In addition, as shown in FIG. 9, instead of providing the sense resistor 42 separately from the transistor ML, the on-resistance of the transistor ML may be used as the sense resistor 42. In this case, the first end of the resistor 43 may be connected to the drain of the transistor ML and the second end of the resistor 43 may be connected to the non-inverting input terminal of the comparator 41, and the first end of the resistor 44 may be connected to the source of the transistor ML and the second end of the resistor 44 may be connected to the inverting input terminal of the comparator 41.

The reverse current detection circuit 16 itself of FIG. 9 may also be provided in the power supply control device 10 of Example EX1_1. However, in Example EX1_1, it is understood that the shift current Isht is fixed at the shift current Isht1.

As described above, the high-level command signal SW_EN functions as an execution command signal that commands the execution of the switching control, and the low-level command signal SW_EN functions as the stop command signal that commands the stop of the switching control. The switching control circuit 11 follows the command of the command signal SW_EN. Therefore, during the low-level period of the command signal SW_EN, the switching control circuit 11 stops the switching control. During the low-level period of the command signal SW_EN, the switching control circuit 11 maintains the output stage circuit MM in the both off state. When starting the switching control in response to the high-level command signal SW_EN (execution command signal that commands the execution of the switching control), the switching control circuit 11 executes the charging control before starting the switching control. The charging control is a control for charging the boot capacitor Cboot, and in the charging control, the logic circuit 13 sets the output stage circuit MM to the output low state continuously or intermittently without setting it to the output high state (that is, sets the transistor ML to the output low state continuously or intermittently while keeping the transistor MH off). In the charging control, when the output stage circuit MM is set to the output low state intermittently, the state of the output stage circuit MM is switched between the output low state and the both off state without being set to the output high state. The charging control performed in Example EX1_2 is particularly referred to as a charging control CC2. In the example of FIG. 11, the charging control CC2 is performed between times t_{C1} and t_{C4}. When the switching control circuit 11 according to Example EX1_2 starts the switching control in response to the rising edge of the command signal SW_EN after the stop period of the switching control has passed, the charging control CC2 is performed before the switching control starts.

On the other hand, the charging control performed in Example EX1_1 is particularly referred to as a charging control CC1. The switching control circuit 11 according to Example EX1_1 performs the charging control CC1 before starting the switching control in response to the rising edge of the command signal SW_EN after the stop period of the switching control has passed. In the example of FIG. 7, the charging control CC1 is performed between times tai and t_{A3}. In the example of FIG. 8, the charging control CC1 is performed between times t₁ and t_{B2}. In the charging control CC1, the switching control circuit 11 sets the output stage circuit MM to the output low state in the state where “Vmnt<Vth_UVLO” is established, and then maintains the output stage circuit MM in the output low state regardless of the magnitude of the coil current IL until the monitoring target voltage Vmnt rises and reaches the threshold voltage Vth_UVLO.

In contrast, in the charging control CC2, the switching control circuit 11 sets the output stage circuit MM to the output low state in the state where “Vmnt<Vth_UVLO” is established, and then executes an operation to maintain the output stage circuit MM in the output low state until the monitoring target voltage Vmnt rises and reaches the threshold voltage Vth_UVLO or the specific reverse current state is detected. In addition, when the specific reverse current state is detected before the monitoring target voltage Vmnt reaches the threshold voltage Vth_UVLO with the output stage circuit MM set to the output low state, the switching control circuit 11 executes the reverse current limiting operation J2 which switches the state of the output stage circuit MM from the output low state to the both off state and maintains the output stage circuit MM in the both off state for a predetermined waiting time Tw before returning it to the output low state. Then, after the start of the charging control CC2, the switching control circuit 11 permits the output stage circuit MM to be set to the output high state after the monitoring target voltage Vmnt reaches the threshold voltage Vth_UVLO, and starts the switching control based on the control signal Spwm. The start of the switching control may be the restart of the switching control.

### Example EX1_3

Example EX1_3 will be described. In Example EX1_3 and Examples EX1_4 and EX1_5 to be described later, the technique shown in Example EX1_2 is applied, and therefore the charging control CC2 is performed.

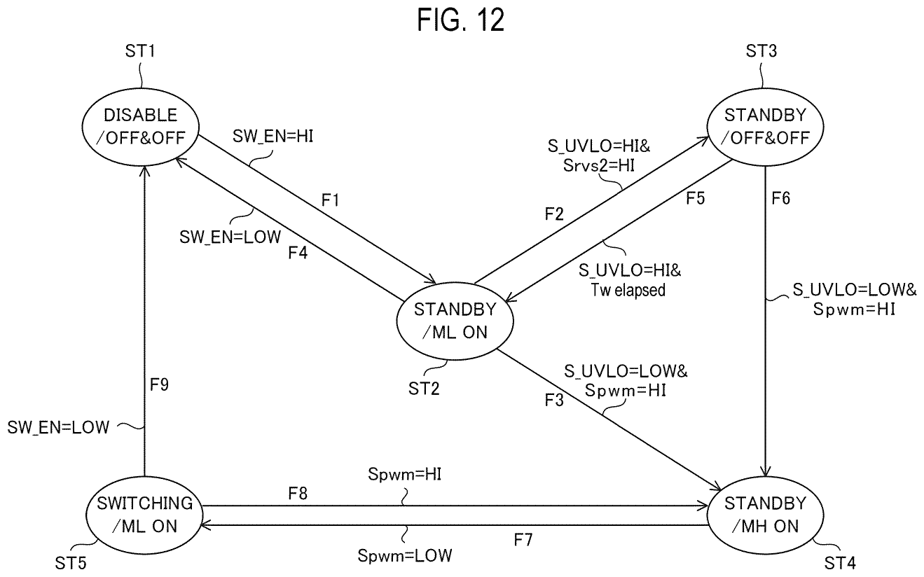

FIG. 12 shows a state transition diagram of the logic circuit 13 according to Example EX1_3. The state of the logic circuit 13 is one of a plurality of states including states ST1 to ST5. It may be understood that a state machine that monitors the state of the logic circuit 13 is provided in the logic circuit 13. In FIG. 12, the state transition according to Example EX1_3 is conceptually shown, states other than the states ST1 to ST5 may be added to the above-mentioned plurality of states in order to perform more precise control, and various signals may be changed according to the control method adopted by the switching control circuit 11 (the same applies to Example EX1_4 to be described later).

The state ST1 is a DISABLE state. In the state ST1, the logic circuit 13 sets the output stage circuit MM to the both off state. The states ST2 and ST3 both belong to a standby state. In the standby state, charging of the boot capacitor Cboot is performed or it is determined whether or the charging of the boot capacitor Cboot is completed. In the state ST2, the logic circuit 13 sets the output stage circuit MM to the output low state. In the state ST3, the logic circuit 13 sets the output stage circuit MM to the both off state. The states ST4 and ST5 both belong to a switching execution state. In the switching execution state, the switching control is executed. In the state ST4, the logic circuit 13 sets the output stage circuit MM to the output high state. In the state ST5, the logic circuit 13 sets the output stage circuit MM to the output low state.

In an initial state of the power supply control device 10, the state of the logic circuit 13 is the state ST1. When the state of the logic circuit 13 is the state ST1, when the rising edge occurs in the command signal SW_EN, a transition from the state ST1 to the state ST2 occurs (transition F1). In the state ST2, the charging of the boot capacitor Cboot is performed. After transition to the state ST2, the monitoring target voltage Vmnt reaches the threshold voltage Vth_UVLO, causing the falling edge in the protection signal S_UVLO (or causing the protection signal S_UVLO to have a low level), which is expressed as the completion of charging of the boot capacitor Cboot, or simply as charging completion. In contrast, charging incompletion refers to a state in which the monitoring target voltage Vmnt is lower than the threshold voltage Vth_UVLO and the protection signal S_UVLO has a high level.

After transition to the state ST2, in a case in which the charging of the boot capacitor Cboot is completed without detecting the specific reverse current state and the control signal Spwm is at a high level, the state transitions from the state ST2 to the state ST4, but in a case in which the specific reverse current state is detected before the charging is completed, the state transitions from the state ST2 to the state ST3 and then returns to the state ST2 after a waiting time Tw, and this operation is repeated until the charging is completed. When the charging is completed after transition between the states ST2 and ST3, transition between the states ST4 and ST5 is repeated according to the control signal Spwm. When the command signal SW_EN becomes a low level during the repeated transition between the states ST4 and ST5, the state returns to the state ST1.

The transition between states will be described in more detail. In the case in which the logic circuit 13 is in the state ST2, when the rising edge occurs in the reverse current detection signal Srvs2 while the protection signal S_UVLO is at a high level, transition from the state ST2 to the state ST3 occurs (transition F2). In the case in which the logic circuit 13 is in the state ST2, when the protection signal S_UVLO is at a low level, the logic circuit 13 transitions from the state ST2 to the state ST4 on a condition that the control signal Spwm is at a high level (transition F3). In the case in which the logic circuit 13 is in the state ST2, when the protection signal S_UVLO has a low level but the control signal Spwm has a low level, the logic circuit 13 waits for the level of the control signal Spwm to switch to a high level before transitioning from the state ST2 to the state ST4. When the logic circuit 13 is in the state ST2 and the command signal SW_EN has a low level, the logic circuit 13 transitions from the state ST2 to the state ST1 (transition F4).

After transitioning from the state ST2 to the state ST3, in a case in which the protection signal S_UVLO has a high level and the waiting time Tw has elapsed, the logic circuit 13 returns from the state ST3 to the state ST2 (transition F5). When the logic circuit 13 is in the state ST3 and the protection signal S_UVLO has a low level, the logic circuit 13 transitions from the state ST3 to the state ST4 on a condition that the control signal Spwm has a high level (transition F6). In reality, after the transition to the state ST3, the charging of the boot capacitor Cboot is not completed when the logic circuit 13 is in the state ST3, but a falling edge may occur in the protection signal S_UVLO in the state ST3 due to the influence of signal delay or noise. In consideration of this, the transition F6 is provided. In the case in which the logic circuit 13 is in the state ST3, when the protection signal S_UVLO has a low level but the control signal Spwm has a low level, the logic circuit 13 waits for the level of the control signal Spwm to switch to a high level before transitioning from the state ST3 to the state ST4.

In the case in which the logic circuit 13 is in the state ST4, when the control signal Spwm is confirmed to have a low level (when a falling edge occurs in the control signal Spwm), the logic circuit 13 transitions from the state ST4 to the state ST5 (transition F7). In the case in which the logic circuit 13 is in the state ST5, when the control signal Spwm is confirmed to have a high level (when a rising edge occurs in the control signal Spwm), the logic circuit 13 transitions from the state ST5 to the state ST4 (transition F8). When the logic circuit 13 is in the state ST5 and the command signal SW_EN has a low level, the logic circuit 13 transitions from the state ST5 to the state ST1 (transition F9). When the logic circuit 13 is in the state ST4 and the command signal SW_EN switches from a high level to a low level, the logic circuit 13 transitions from the state ST4 to the state ST5 in response to the falling edge of the control signal Spwm, and then transitions to the state ST1 based on the low level command signal SW_EN.

The period when the logic circuit 13 is in the state ST1 belongs to the stop period of the switching control. The charging control CC2 (see FIG. 11) described in Example EX1_2 includes the transition between the states ST2 and ST3. The switching control circuit 11 according to Example EX1_2 and Example EX1_3 performs the charging control CC2 before the start of the switching control when the switching control is started based on the reception of the high-level command signal SW_EN (execution command signal) after the stop period of the switching control, and does not execute the charging control CC2 (prohibits the charging control CC2) during the execution period of the switching control after the start of the switching control. This is because the monitoring target voltage Vmnt does not drop significantly during the period in which the switching control is continuously executed after the start of the switching control (that is, during the period in which the transition between the states ST4 and ST5 is repeated). Therefore, when the logic circuit 13 is in the state ST4 or ST5, there is no need to check the completion of charging (that is, the logic circuit 13 does not need to check the level of the protection signal S_UVLO).

### Example EX1_4

Example EX1_4 will be described. Example EX1_4 is a partial modification of Example EX1_3. For matters not specifically described in Example EX1_4, the matters shown in Example EX1_3 are also applied to Example EX1_4 unless contradictory.

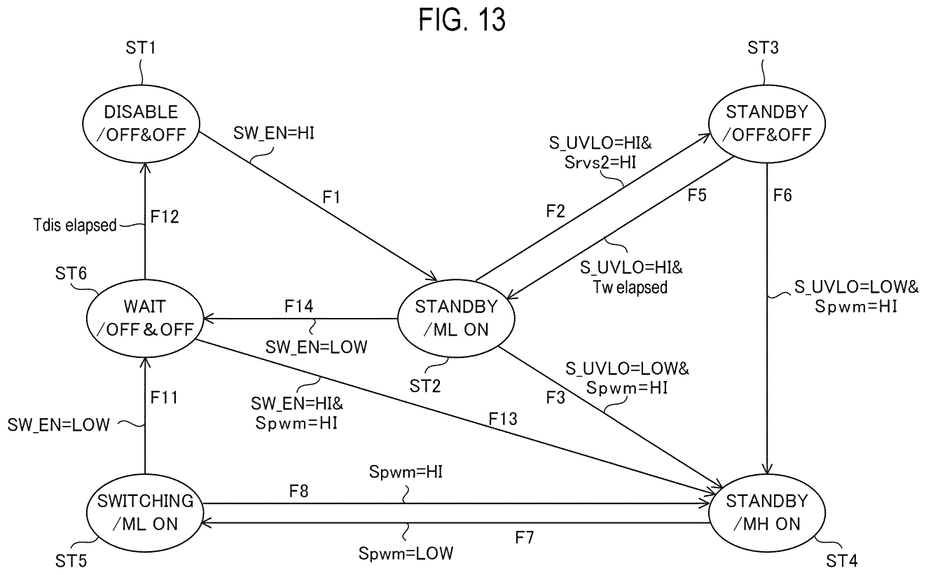

FIG. 13 shows a state transition diagram of the logic circuit 13 according to Example EX1_4. The state of the logic circuit 13 is one of a plurality of states including states ST1 to ST6. In Example EX1_4, the state ST6 is added in comparison with Example EX1_3 (FIG. 12). The state ST6 is a WAIT state for waiting for a certain period of time before generating the transition to the state ST1 after executing the switching control and stopping the switching control. In the state ST6, the logic circuit 13 sets the output stage circuit MM to the both off state.

The transition between the states shown in FIG. 13 will be described. A process from the state ST1 to the state ST4 through the state ST2 or through the states ST2 and ST3 is as described in Example EX1_3. The switching control starts at the point of transition to the state ST4. The switching control involves repeated transition between the states ST4 and ST5. In Example EX1_4, after the start of the switching control, in the case in which the logic circuit 13 is in the state ST5, when the command signal SW_EN has a low level, the logic circuit 13 transitions from the state ST5 to the state ST6 instead of the state ST1 (transition F11). In the case in which the logic circuit 13 is in the state ST4, when the command signal SW_EN switches from high level to low level, the logic circuit 13 transitions from the state ST4 to the state ST5 in response to the falling edge of the control signal Spwm, and then transitions to the state ST6 based on the low-level command signal SW_EN.

When the logic circuit 13 transitions from the state ST5 to the state ST6, the logic circuit 13 starts measuring an elapsed time Tstp using its own timer (not shown). The elapsed time Tstp is a time elapsed from the time of transition from the state ST5 to the state ST6. The time elapsed from the time of transition from the state ST5 to the state ST6 is the time elapsed since the switching control by the repeated transition between the states ST4 and ST5 was stopped (stop time of the switching control). In the state ST6, the logic circuit 13 monitors whether or not the elapsed time Tstp reaches a predetermined discharging reference time Tdis. In the state ST6, the logic circuit 13 (state machine in the logic circuit 13) generates transition from the state ST6 to the state ST1 when the elapsed time Tstp reaches the discharging reference time Tdis while the command signal SW_EN is maintained at a low level (transition F12), while generating transition from the state ST6 to the state ST4 when the command signal SW_EN is switched to a high level and the control signal Spwm is set to a high level before the elapsed time Tstp reaches the discharging reference time Tdis (transition F13).

In the state transition diagram (see FIG. 12) according to Example EX1_3, the transition to the state ST4 in response to the rising edge of the command signal SW_EN always passes through the state ST2, which may result in a deterioration in power efficiency. In addition, once the output stage circuit MM is set to the low output state in the state ST2, there is a possibility that the response may be deteriorated. On the other hand, even if the switching control is stopped in response to the falling edge of the command signal SW_EN after the switching control is executed, when the switching control is stopped for a short period of time, the charging voltage of the boot capacitor Cboot will not drop significantly. In consideration of this, the state ST6 is added, and when the switching control is stopped for a short period of time, direct transition from the state ST6 to the state ST4 is made. On the other hand, when the switching control is stopped for a long period of time, transition from the state ST6 to the state ST1 is made. In order to transition to the state ST4 after transitioning to the state ST1, transition to the state ST2 is made once, and the charging state of the boot capacitor Cboot is confirmed before transitioning to the state ST4.

In addition, in the state transition diagram of FIG. 13, in the case in which the logic circuit 13 is in the state ST2, when the command signal SW_EN has a low level, the state transitions from the state ST2 to the state ST6 instead of the state ST1 (transition F14). The operation after the transition from the state ST2 to the state ST6 is the same as the operation after the transition from the state ST5 to the state ST6. Here, the elapsed time Tstp when the state ST2 transitions to the state ST6 refers to the elapsed time from the time of transition from the state ST2 to the state ST6. However, in the case in which the logic circuit 13 is in the state ST2, when the command signal SW_EN has a low level, taking into consideration the possibility that the charging is insufficient, the state transition may be made from the state ST2 to the state ST1 instead of the state ST6, as in Example EX1_3 (see FIG. 13).

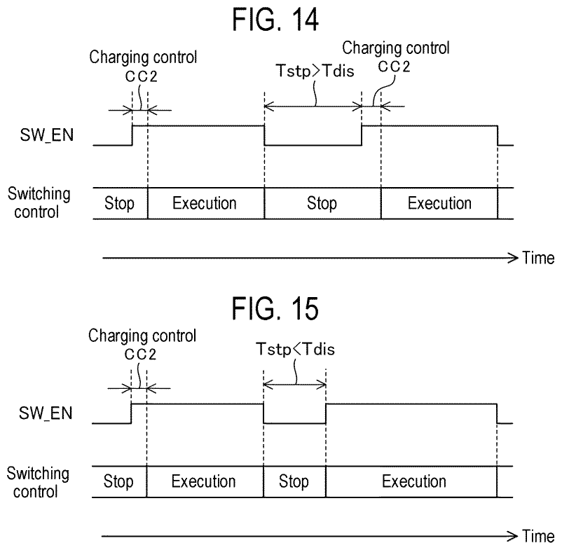

A flow of operation related to the state ST6 will be supplemented with reference to FIG. 14 and FIG. 15. When the switching control circuit 11 receives an execution command signal (high-level command signal SW_EN) that commands the execution of the switching control while the logic circuit 13 is in the state ST1, it transitions to the state ST4 through the charging control CC2 and then starts the switching control. The charging control CC2 is accompanied by transition to at least the state ST2. After that, when the switching control circuit 11 receives a stop command signal (low-level command signal SW_EN) that commands the stop of the switching control, it stops the switching control and then measures the elapsed time Tstp from the stop of the switching control based on the stop command signal. When the switching control circuit 11 receives the execution command signal (high-level command signal SW_EN) again after the elapsed time Tstp reaches the discharging reference time Tdis, the switching control circuit 11 restarts the switching control after going through the charging control CC2 again, as shown in FIG. 14. On the other hand, when the switching control circuit 11 receives the execution command signal again before the elapsed time Tstp reaches the discharging reference time Tdis, the switching control circuit 11 restarts the switching control without going through the charging control CC2 again, as shown in FIG. 15.

### Example EX1_5

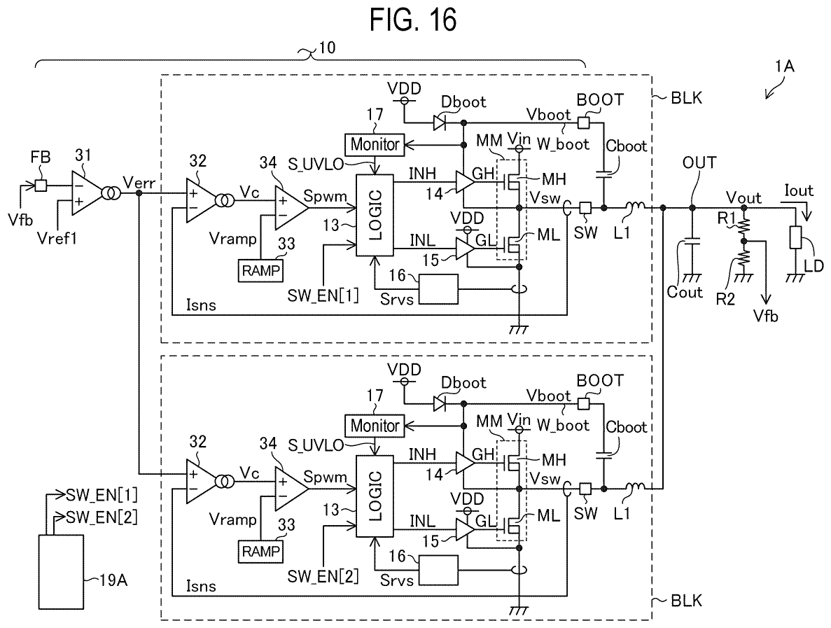

Example EX1_5 will be described. The switching power supply device 1 shown in FIG. 1 is provided with the following circuit blocks (hereinafter, referred to as unit circuit blocks BLK). With reference to FIG. 5 and FIG. 16, each unit circuit block BLK includes a differential amplifier 32, a ramp voltage generating circuit 33, and a comparator 34, as well as a logic circuit 13, a high-side driver 14, a low-side driver 15, a reverse current detection circuit 16, a monitor circuit 17, an output stage circuit MM, a boot capacitor Cboot, a coil L1, a diode Dboot, a switch terminal SW, and a boot terminal BOOT.

FIG. 16 is an overall configuration diagram of a switching power supply device 1A which is a switching power supply device 1 according to Example EX1_5. The switching power supply device 1A includes unit circuit blocks BLK for a plurality of channels. The switching power supply device 1A is also provided with an output capacitor Cout, feedback resistors R1 and R2, an error amplifier 31, and a feedback terminal FB, as in the switching power supply device 1 of FIG. 1, and the connections therebetween are as described above. In the switching power supply device 1A, the output capacitor Cout, the feedback resistors R1 and R2, the error amplifier 31, and the feedback terminal FB are shared by the unit circuit blocks BLK of the plurality of channels. A power supply control device 10 provided in the switching power supply device 1A includes the unit circuit blocks BLK for the plurality of channels, the error amplifier 31, the feedback terminal FB, and a switching management circuit 19A. However, it is understood that the boot capacitor Cboot and the coil L1 of each channel are provided outside the power supply control device 10.

The switching power supply device 1A shown in FIG. 16 is provided with unit circuit blocks BLK for two channels, but it may be provided with unit circuit blocks BLK for three or more channels. The unit circuit blocks BLK for two channels are composed of unit circuit blocks BLK for first and second channels. The internal configuration of each unit circuit block BLK and the operation of the components in each unit circuit block BLK are as described above with reference to FIG. 1 and the like, and in particular the operations shown in Examples EX1_2 to EX1_4 are applied to each unit circuit block BLK in the switching power supply device 1A. Here, the first end of the coil L1 of the first channel is connected to the switch terminal SW of the first channel, the first end of the coil L1 of the second channel is connected to the switch terminal SW of the second channel, the second end of the coil L1 of the first channel and the second end of the coil L1 of the second channel are connected to a common output terminal OUT, and the output capacitor Cout common to the first and second channels is provided between the common output terminal OUT and the ground.

In the switching power supply device 1A, switching control may be performed individually in the unit circuit blocks BLK of the plurality of channels, in which case multi-phase control may be performed by shifting the phase of the switching control between the plurality of channels. When the switching control is performed in the first channel, in the unit circuit block BLK of the first channel, the output duty of the output stage circuit MM of the first channel is controlled so that a voltage difference (Vfb−Vref1) approaches zero. When the switching control is performed in the second channel, in the unit circuit block BLK of the second channel, the output duty of the output stage circuit MM of the second channel is controlled so that the voltage difference (Vfb−Vref1) approaches zero. The same applies when the unit circuit blocks BLK of other channels are provided.

The switching management circuit 19A includes the functions of the above-described switching management circuit 19. The switching management circuit 19A outputs the command signal SW_EN to the unit circuit block BLK of each channel. The operation of the unit circuit block BLK (particularly the operation of the logic circuit 13) in response to the command signal SW_EN is as described above, and in each channel, the switching control is performed only during a period when the corresponding command signal SW_EN is at a high level, and the switching control is stopped during a period when the corresponding command signal SW_EN is at a low level. In each channel, after a rising edge occurs in the corresponding command signal SW_EN, the switching control is started after going through the above-described charging control CC2 (see FIG. 11).

The command signal SW_EN output from the switching management circuit 19A to the unit circuit block BLK of the first channel is particularly referred to as a command signal SW_EN[1]. The command signal SW_EN output from the switching management circuit 19A to the unit circuit block BLK of the second channel is particularly referred to as a command signal SW_EN[2]. A high-level command signal SW_EN[i] functions as an execution command signal that commands the unit circuit block BLK of the i-th channel to execute the switching control, and a low-level command signal SW_EN[i] functions as a stop command signal that commands the unit circuit block BLK of the i-th channel to stop the switching control. Here, i represents 1 or 2. The above multi-phase control may be performed during a period when both command signals SW_EN[1] and SW_EN[2] have a high level.

The switching management circuit 19A may adjust the number of operating channels NUM by controlling the levels of the command signals SW_EN[1] and SW_EN[2]. The number of operating channels NUM is a total number of unit circuit blocks BLK for which switching control is performed in the switching power supply device 1A. When only the first and second channels are considered, the switching management circuit 19A may set the number of operating channels NUM to 1 by setting the command signal SW_EN[1] to a high level and the command signal SW_EN[2] to a low level, at which time the switching control is performed in the unit circuit block BLK of the first channel, while the switching control is stopped in the unit circuit block BLK of the second channel. The switching management circuit 19A may set the number of operating channels NUM to 2 by setting both command signals SW_EN[1] and SW_EN[2] to a high level, at which time the switching control is performed in both unit circuit blocks BLK of the first and second channels.

For example, the switching management circuit 19A may adjust the number of operating channels NUM according to the load current Iout. Alternatively, for example, the switching management circuit 19A may adjust the number of operating channels NUM based on a command signal supplied to the power supply control device 10 from an external device of the power supply control device 10. Now, assume a situation that the command signal SW_EN[1] is set to a high level and the command signal SW_EN[2] is set to a low level for a long time and the output voltage Vout is stabilized at 5 V, which is an example of the target voltage Vtg, by performing the switching control only in the unit circuit block BLK of the first channel. In addition, assume that the power supply voltage VDD is also 5 V. In this situation, the output stage circuit MM of the second channel is in the both off state, so that the switch voltage Vsw of the second channel is 5 V, and therefore the boot capacitor Cboot of the second channel is not charged. In this situation, in the case in which the command signal SW_EN[2] is switched to a high level to perform the switching control in the second channel as well, when the charging control CC1 is performed in the second channel, the output voltage Vout may temporarily drop significantly (see FIG. 8). In contrast, when the charging control CC2 responds to the switching of the command signal SW_EN[2] to a high level and is performed in the second channel (when the charging control CC2 is performed before the start of the switching control and the switching control of the second channel is started after the monitoring target voltage Vmnt of the second channel reaches the threshold voltage Vth_UVLO), the number of operating channels NUM may be increased with almost no decrease in the output voltage Vout.

### Second Embodiment

A second embodiment of the present disclosure will be described. The second embodiment is based on the first embodiment, and the matters shown in the first embodiment may also be applied to the second embodiment unless contradictory. However, in interpreting the technique shown in the second embodiment, the description in the second embodiment may take precedence over the matters that contradict the matters shown in the first embodiment.

The charging control used in the second embodiment may be the charging control CC1 or the charging control CC2 (see FIG. 8 and FIG. 11). In the second embodiment, a configuration example of the monitor circuit 17 is shown. Any configuration example of the monitor circuit 17 shown in the second embodiment may be applied to the monitor circuit 17 of the first embodiment. Any technique shown in the second embodiment may be applied to the first embodiment.

The second embodiment includes the following Examples EX2_1 to EX2_5. The techniques related to the monitor circuit 17 will be described in Examples EX2_1 to EX2_5.

### Example EX2_1

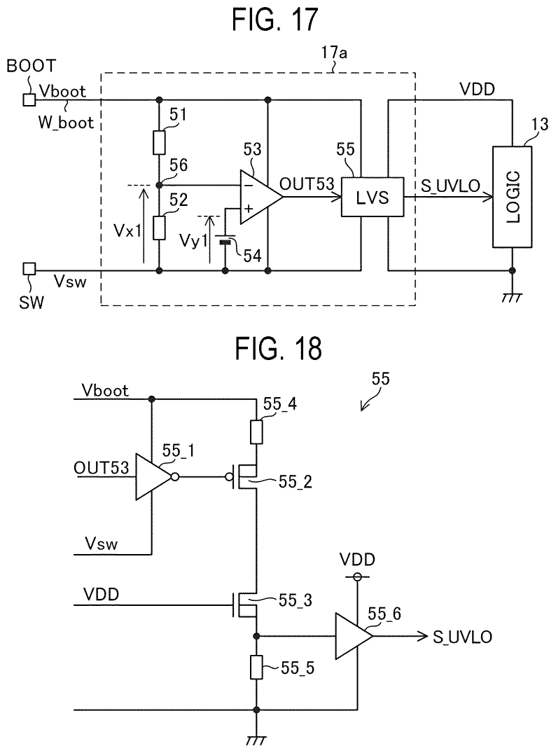

Example EX2_1 will be described. FIG. 17 shows a configuration of a monitor circuit 17a which is the monitor circuit 17 according to Example EX2_1. The monitor circuit 17a includes voltage dividing resistors 51 and 52, a comparator 53, a reference voltage source 54, and a level shifter 55. In the monitor circuit 17a, a voltage difference between the boot terminal BOOT and the switch terminal SW is monitored by the comparator 53, and the output level of the comparator 53 is converted to the input level of the logic circuit 13 by using the level shifter 55.

A configuration and operation of the monitor circuit 17a will be described in detail. A first end of the voltage dividing resistor 51 is connected to the boot terminal BOOT and the boot wiring W_boot and receives the boot voltage Vboot. A second end of the voltage dividing resistor 51 and a first end of the voltage dividing resistor 52 are commonly connected at a node 56. A second end of the voltage dividing resistor 52 is connected to the switch terminal SW. Therefore, the switch voltage Vsw is applied to a second end of the voltage dividing resistor 52. A voltage at the node 56 is a voltage (Vsw+Vx1). The voltage (Vsw+Vx1) is higher by the voltage Vx1 than the switch voltage Vsw. The voltage Vx1 is a voltage across the voltage dividing resistor 52.

A voltage dividing circuit consisting of the voltage dividing resistors 51 and 52 generates the voltage Vx1 by dividing a difference voltage between the boot voltage Vboot and the switch voltage Vsw. The inverting input terminal of the comparator 53 is connected to the node 56 and receives the voltage (Vsw+Vx1). The reference voltage source 54 generates a predetermined positive reference voltage Vy1 based on the potential of the switch terminal SW and supplies a voltage (Vsw+Vy1), which is higher by the reference voltage Vy1 than the switch voltage Vsw, to the non-inverting input terminal of the comparator 53. The comparator 53 operates with the boot voltage Vboot as a high-potential power supply voltage and the switch voltage Vsw as a low-potential power supply voltage. The comparator 53 compares the voltage (Vsw+Vx1) at its inverting input terminal with the voltage (Vsw+Vy1) at its non-inverting input terminal and outputs a signal OUT53 indicating the high/low relationship between them. The signal OUT53 is a binary signal having a high level or a low level. The high level of the signal OUT53 has the potential of the boot voltage Vboot, and the low level of the signal OUT53 has the potential of the switch voltage Vsw. The signal OUT53 is input to the level shifter 55. The comparator 53 outputs the low level signal OUT53 when “Vsw+Vx1>Vsw+Vy1” is established, and outputs the high-level signal OUT53 when “Vsw+Vx1<Vsw+Vy1” is established. When “Vsw+Vx1=Vsw+Vy1” is established, the signal OUT53 has a low level or a high level. In practice, a hysteresis characteristic may be given to the comparator 53. Each constant in the monitor circuit 17a is set so that the level of the signal OUT53 switches from a high level to a low level at the point when the voltage (Vboot-Vsw) rises and reaches the threshold voltage Vth_UVLO.

The level shifter 55 is supplied with the boot voltage Vboot, the switch voltage Vsw, the power supply voltage VDD, and the ground voltage, and the level shifter 55 generates and outputs the protection signal S_UVLO by shifting the level of the signal OUT53 based on the supplied voltages. In the protection signal S_UVLO output from the level shifter 55, the high level has the potential of the power supply voltage VDD, and the low level has the ground potential. The level shifter 55 outputs the high-level protection signal S_UVLO when the signal OUT53 has a high level, and outputs the low-level protection signal S_UVLO when the signal OUT53 has a low level. The protection signal S_UVLO from the level shifter 55 is supplied to the logic circuit 13. The logic circuit 13 operates based on the power supply voltage VDD with the ground potential as a reference and may properly read the logical value of the protection signal S_UVLO from the level shifter 55.

FIG. 18 shows an example of a configuration of the level shifter 55. The level shifter 55 of FIG. 18 includes an inverter circuit 55_1, transistors 55_2 and 55_3, resistors 55_4 and 55_5, and a buffer circuit 55_6. The transistor 55_2 is a P-channel MOSFET, and the transistor 55_3 is an N-channel MOSFET.

The inverter circuit 55_1 operates with the boot voltage Vboot and the switch voltage Vsw as the positive and negative power supply voltages, respectively, and outputs an inverted signal of the signal OUT53 to the gate of the transistor 55_2. In the output signal of the inverter circuit 55_1, the high level has the potential of the boot voltage Vboot, and the low level has the potential of the switch voltage Vsw.

The boot voltage Vboot is supplied to a first end of the resistor 55_4. A second end of the resistor 55_4 is connected to the source of the transistor 55_2. The drain of the transistor 55_2 is connected to the drain of the transistor 55_3. The source of the transistor 55_3 is connected to a first end of the resistor 55_5 and to the input end of the buffer circuit 55_6. A second end of the resistor 55_5 is connected to the ground. The power supply voltage VDD is supplied to the gate of the transistor 55_3. The buffer circuit 55_6 is driven based on the power supply voltage VDD with the ground potential as a reference. The buffer circuit 55_6 outputs the high-level signal S_UVLO when a voltage at its input end (that is, the source voltage of the transistor 55_3) is equal to or higher than a boundary voltage, and outputs the low-level signal S_UVLO when it is lower than the boundary voltage. The boundary voltage is approximately ½ of the power supply voltage VDD.

An operation of the level shifter 55 of FIG. 18 will be described. During a high-level period of the signal OUT53, the inverter circuit 55_1 turns on the transistor 55_2 by supplying a low-level signal (a signal having the potential of the switch voltage Vsw) to the gate of the transistor 55_2. When the transistor 55_2 is turned on, the drain current of the transistor 55_2 flows through the transistor 55_3 and the resistor 55_5, and a voltage higher than the boundary voltage is applied to the input terminal of the buffer circuit 55_6 by the drain current, so that the protection signal S_UVLO becomes a high level. Conversely, during a low-level period of the signal OUT53, the inverter circuit 55_1 turns off the transistor 55_2 by supplying a high-level signal (a signal having the potential of the boot voltage Vboot) to the gate of the transistor 55_2. When the transistor 55_2 is turned off, a voltage (a voltage of 0 V) lower than the boundary voltage is applied to the input terminal of the buffer circuit 55_6, so that the protection signal S_UVLO becomes a low level. In addition, by providing the transistor 55_3, an input voltage to the buffer circuit 55_6 is limited to a voltage lower by a gate threshold voltage of the transistor 55_3 than the power supply voltage VDD, and as a result, the buffer circuit 55_6 is protected.

In the level shifter 55 of FIG. 18, it is necessary to use high-breakdown voltage elements as the transistors 55_2 and 55_3. The high-breakdown voltage elements have resistance to voltages exceeding the power supply voltage VDD. Since the element size of the high-breakdown voltage elements is relatively large, the use of the high-breakdown voltage elements increases the cost of the semiconductor chip. In addition, a relatively large parasitic capacitance is added between the source and drain of the transistor formed as the high-breakdown voltage element and a semiconductor substrate of the semiconductor chip. When the switch voltage Vsw fluctuates, a current flows through the parasitic capacitance, which easily generates noise in the level shifter 55. Therefore, it is preferable to add a malfunction prevention circuit to the level shifter 55 of FIG. 18 in order to suppress the influence of such noise.

### Example EX2_2

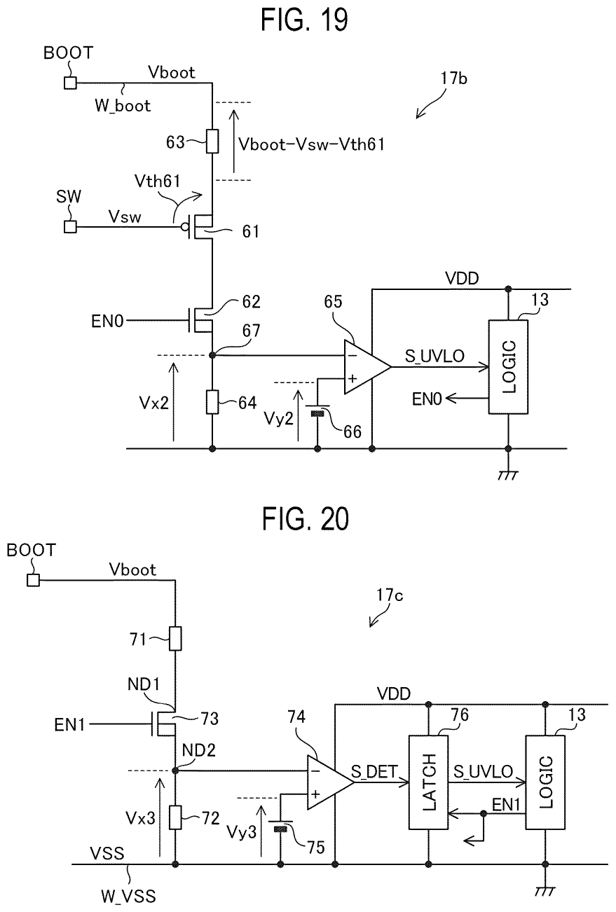

Example EX2_2 will be described. FIG. 19 shows a configuration of a monitor circuit 17b, which is the monitor circuit 17 according to Example EX2_2. The monitor circuit 17b includes transistors 61 and 62, resistors 63 and 64, a comparator 65, and a reference voltage source 66. The transistor 61 is a P-channel MOSFET, and the transistor 62 is an N-channel MOSFET. The monitor circuit 17b shifts the voltage between the boot terminal BOOT and the switch terminal SW to a voltage (Vx2) having an appropriate level before supplying the voltage (Vx2) to the comparator 65.

A configuration and operation of the monitor circuit 17b will be described in detail. A first end of the resistor 63 is connected to the boot terminal BOOT and the boot wiring W_boot and receives the boot voltage Vboot. A second end of the resistor 63 is connected to the source of the transistor 61. The drain of the transistor 61 is connected to the drain of the transistor 62. The source of the transistor 62 is connected to a first end of the resistor 64 at a node 67, and a second end of the resistor 64 is connected to the ground. The gate of the transistor 61 is connected to the switch terminal SW and receives the switch voltage Vsw. A signal EN0 is supplied to the gate of the transistor 62. The inverting input terminal of the comparator 65 is connected to the node 67 and receives the voltage Vx2 at the node 67. The voltage Vx2 is equal to a voltage drop generated across the resistor 64. The reference voltage source 66 generates a predetermined positive reference voltage Vy2 based on the ground potential and supplies the generated reference voltage Vy2 to the non-inverting input terminal of the comparator 65.

The comparator 65 compares the voltage Vx2 at its inverting input terminal with the voltage Vy2 at its non-inverting input terminal and outputs a signal indicating the high/low relationship between them, as the protection signal S_UVLO. The comparator 65 operates based on the power supply voltage VDD with the ground potential as a reference, and in the protection signal S_UVLO output by the comparator 65, the high level has the potential of the power supply voltage VDD, and the low level has the ground potential.

The signal EN0 is a binary signal having a high level or a low level. The low-level signal EN0 has the ground potential. Therefore, during the low-level period of the signal EN0, the transistor 62 is turned off and the voltage Vx2 is 0 V, and as a result, the protection signal S_UVLO from the comparator 65 has a high level. The high-level signal EN0 has a potential sufficiently higher than the gate threshold voltage of the transistor 62. Therefore, during the high-level period of the signal EN0, the transistor 62 is turned on and a current according to the voltage (Vboot−Vsw) flows through the resistor 64 via the transistor 62. The signal EN0 is a signal output from the logic circuit 13, and the level of the signal EN0 is basically fixed at a high level. For example, the signal EN0 may have a low level during the low-level period of the command signal SW_EN, but the level of the signal EN0 is switched to a high level at the rising edge of the command signal SW_EN, and thereafter the level of the signal EN0 is continuously maintained at the high level from immediately before the start of the switching control through the start of the switching control and throughout the execution period of the switching control. In Example EX2_2, unless otherwise stated, it is considered that the signal EN0 has a high level.

When the charging of the boot capacitor Cboot progresses to a certain extent, a current flows through the resistor 63 and the transistor 61, and a voltage drop that occurs at the resistor 63 at this time is a voltage (Vboot−Vsw−Vth61). Here, Vth61 represents the gate threshold voltage of the transistor 61. The product of this voltage (Vboot−Vsw−Vth61) and the ratio (R64/R63) is the voltage Vx2. Therefore, assuming that the gate threshold voltage Vth61 is sufficiently low, the voltage (Vboot-Vsw) may be monitored by the voltage Vx2. R63 and R64 represent the resistance values of the resistors 63 and 64, respectively.

The transistor 62 has a function as a switch, and also has a voltage clamping function that limits the voltage Vx2 to a voltage lower by the gate threshold voltage of the transistor 62 than the high level of the signal EN0 so that the voltage Vx2 does not exceed the breakdown voltage of the comparator 65. Typically, the high-level signal EN0 has the potential of the power supply voltage VDD, but it may have other potentials. Each constant in the monitor circuit 17b is set so that the output signal (S_UVLO) of the comparator 65 switches from a high level to a low level when the voltage (Vboot-Vsw) rises and reaches the threshold voltage Vth_UVLO.

In the monitor circuit 17b of FIG. 19, it is necessary to use high-breakdown voltage elements as the transistors 61 and 62. The high-breakdown voltage elements have resistance to voltages exceeding the power supply voltage VDD. Since the element size of the high-breakdown voltage elements is relatively large, the use of the high-breakdown voltage elements increases the cost of the semiconductor chip. In addition, a relatively large parasitic capacitance is added between the source and drain of the transistor formed as the high-breakdown voltage element and a semiconductor substrate of the semiconductor chip. When the switch voltage Vsw fluctuates, a current flows through the parasitic capacitance, which easily generates noise in the monitor circuit 17b. Therefore, it is preferable to add a malfunction prevention circuit to the monitor circuit 17b of FIG. 19 in order to suppress the influence of such noise.

### Example EX2_3

Example EX2_3 will be described. FIG. 20 shows a configuration of a monitor circuit 17c, which is the monitor circuit 17 according to Example EX2_3. The monitor circuit 17c includes voltage dividing resistors 71 and 72, a transistor 73 (insertion transistor), a comparator 74, a reference voltage source 75, and a latch circuit 76. The transistor 73 is an N-channel MOSFET. Here, a voltage on a reference wiring W_VSS is referred to as a voltage VSS. The reference wiring W_VSS is connected to the ground terminal GND (see FIG. 1) and therefore has the ground potential (the same applies to other Examples to be described later). That is, the voltage VSS is 0 V.

In Example EX2_3, attention is paid to the fact that the over-discharging of the boot capacitor Cboot occurs only during the stop period of the switching control. It is sufficient to confirm the sufficiency/insufficiency of the charging of the boot capacitor Cboot before the start of the switching control, more precisely, immediately before the transistor MH is switched on for the first time by the switching control. The monitor circuit 17c of FIG. 20 has a circuit configuration partially similar to that of the monitor circuit 17b of FIG. 19, but the operations of the two are completely different. In FIG. 20, the transistor 73 has both a switch function and a voltage clamp function, and during the on period of the transistor 73, the boot voltage Vboot is divided based on the ground potential and a voltage Vx3 having a divided value is input to the comparator 74. That is, while the monitor circuit 17b of FIG. 19 detects the difference between the voltages Vboot and Vsw, the monitor circuit 17c of FIG. 20 detects a difference between the voltages Vboot and VSS. However, during the on period of the transistor ML, the switch voltage Vsw is approximately equal to the voltage VSS, so that the detection of the difference between the voltages Vboot and VSS is equivalent to the detection of the difference between the voltages Vboot and Vsw. That is, in the monitor circuit 17c of FIG. 20, when a signal EN1 is set to a high level during the on period of the transistor ML to control the transistor 73 to be on, the difference between the voltages Vboot and Vsw may be observed from a voltage drop of the voltage dividing resistor 72.

A configuration and operation of the monitor circuit 17c will be described in detail. A first end of the voltage dividing resistor 71 is connected to the boot terminal BOOT and the boot wiring W_boot and receives the boot voltage Vboot. A second end of the voltage dividing resistor 71 is connected to a node ND1. A first end of the voltage dividing resistor 72 is connected to a node ND2. The second end of the voltage dividing resistor 72 is connected to the reference wiring W_VSS. The transistor 73 is interposed between the nodes ND1 and ND2. That is, the drain of the transistor 73 is connected to the node ND1, and the source of the transistor 73 is connected to the node ND2. The signal EN1 is supplied to the gate of the transistor 73 from the logic circuit 13. The inverting input terminal of the comparator 74 is connected to the node ND2 and receives the voltage Vx3 at the node ND2. The voltage Vx3 is equal to the voltage drop generated by the voltage dividing resistor 72. The reference voltage source 75 generates a predetermined positive reference voltage Vy3 based on the ground potential and supplies the generated reference voltage Vy3 to the non-inverting input terminal of the comparator 74.

The comparator 74 compares the voltage Vx3 at its inverting input terminal with the voltage Vy3 at its non-inverting input terminal and outputs a detection signal S_DET indicating the high/low relationship between them. The detection signal S_DET has a high level when “Vx3<Vy3” is established, a low level when “Vx3>Vy3” is established, and a low level or a high level when “Vx3=Vy3” is established. The protection signal S_UVLO based on the detection signal S_DET is output from the latch circuit 76 to the logic circuit 13. The comparator 74 and the latch circuit 76 operate based on the power supply voltage VDD with the ground potential as a reference. In the detection signal S_DET and the protection signal S_UVLO, the high level has the potential of the power supply voltage VDD, and the low level has the ground potential.

The signal EN1 is a binary signal having a high level or a low level. The low-level signal EN1 has the ground potential. Therefore, during the low-level period of the signal EN1, the transistor 73 is turned off and the voltage Vx3 is 0 V, and as a result, the detection signal S_DET from the comparator 74 has a high level. The high-level signal EN1 has a potential sufficiently higher than the gate threshold voltage of the transistor 73. Therefore, during the high-level period of the signal EN1, the transistor 73 is turned on and a current corresponding to a difference between the voltages Vboot and VSS, that is, a current corresponding to the voltage (Vboot−VSS), flows through the voltage dividing resistor 72 via the transistor 73. The logic circuit 13 may set the signal EN1 to a high level during the on period of the transistor ML. The logic circuit 13 sets the signal EN1 to a low level during a period when the output stage circuit MM is set to the output high state and during a period when the output stage circuit MM is set to the both off state. However, the signal EN1 may be set to a high level during the period when the output stage circuit MM is set to the output high state or the both off state. However, since a voltage equivalent to the difference between the voltages Vboot and Vsw appears at the node ND2 only during the on period of the transistor ML, the detection signal S_DET is invalid during the period when the output stage circuit MM is set to the output high state or the both off state.

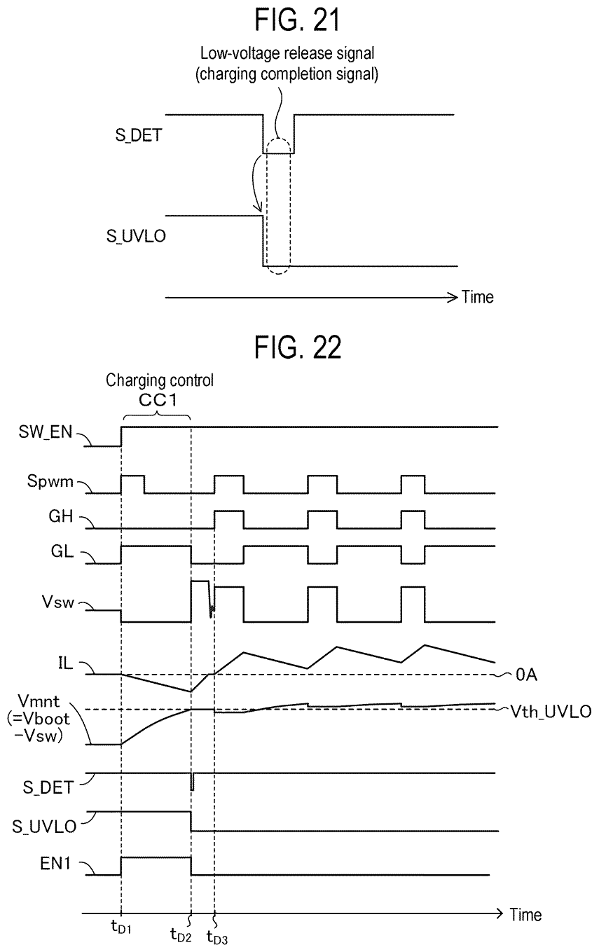

In the initial state of the power supply control device 10, the protection signal S_UVLO from the latch circuit 76 has a high level, and the protection signal S_UVLO has a high level in principle. The latch circuit 76 monitors the level of the detection signal S_DET during the high-level period of the signal EN1 (hence during the on period of the transistors ML and 73). Then, when a falling edge occurs in the detection signal S_DET during the high-level period of the signal EN1 as shown in FIG. 21, the latch circuit 76 latches the low level of the detection signal S_DET to switch the level of the protection signal S_UVLO from the high level to the low level. The latch circuit 76 invalidates the detection signal S_DET during the low-level period of the signal EN1 and does not respond to the detection signal S_DET during the low-level period of the signal EN1. The latch circuit 76 may be built into the logic circuit 13. Hereinafter, the low-level detection signal S_DET or the low-level protection signal S_UVLO is referred to as a low-voltage release signal. The low-voltage release signal is a signal indicating that a state in which the monitoring target voltage Vmnt is too low has been released and is a signal that releases the prohibition of the on control of the transistor MH, and the logic circuit 13 may control the transistor MH to be turned on only after receiving the low-voltage release signal. The low-level detection signal S_DET or the protection signal S_UVLO may be said to be a signal indicating that the charging of the boot capacitor Cboot is complete, and therefore the low-voltage release signal may be interpreted as a charging completion signal.

The voltage dividing resistors 71 and 72 form a voltage dividing circuit that divides a voltage between the reference wiring W_VSS and the boot wiring W_boot, that is, the voltage (Vboot-VSS). However, the voltage division in this voltage dividing circuit is implemented only during the on period of the transistor 73. During the on period of the transistor 73, when the drain-source voltage of the transistor 73 is sufficiently small to be ignored, the voltage Vx3 is expressed by “Vx3=(Vboot−VSS)×R₇₂/(R₇₁+R₇₂)”. Here, R₇₁ and R₇₂ represent the resistance values of the voltage dividing resistors 71 and 72, respectively. The voltage Vx3 during the on period of the transistors ML and 73 is specifically referred to as an evaluation voltage Vx3. As described above, since the switch voltage Vsw is approximately equal to the voltage VSS during the on period of the transistor ML, the evaluation voltage Vx3 may be considered to be expressed as “Vx3=(Vboot−Vsw)×R₇₂/(R₇₁+R₇₂)”. In other words, the voltage dividing circuit consisting of the voltage dividing resistors 71 and 72 divides the voltage between the reference wiring W_VSS and the boot wiring W_boot during the on period of the transistors ML and 73 to generate the evaluation voltage Vx3 corresponding to the monitoring target voltage Vmnt (=Vboot−Vsw) at the node ND2. The monitor circuit 17c compares the evaluation voltage Vx3 with the reference voltage Vy3 to determine whether or not to supply the low-voltage release signal to the logic circuit 13.

The transistor 73 has a function as a switch, and also has a voltage clamping function that limits the voltage Vx3 to a voltage lower by the gate threshold voltage of the transistor 73 than the high level of the signal EN1 so that the voltage Vx3 does not exceed the breakdown voltage of the comparator 74. Typically, the high-level signal EN1 has the potential of the power supply voltage VDD, but it may have other potentials. Under the assumption that the transistors ML and 73 are turned on, each constant in the monitor circuit 17c is set so that the detection signal S_DET of the comparator 74 switches from a high level to a low level at the point when the voltage (Vboot-Vsw) rises and reaches the threshold voltage Vth_UVLO.

The transistor 73 is a high-breakdown voltage element. In the monitor circuit 17c of FIG. 20, there is no need to use any high-breakdown voltage element other than the transistor 73. Therefore, in the monitor circuit 17c of FIG. 20, the size of the monitor circuit on the semiconductor chip may be made smaller than that of the monitor circuits 17a and 17b shown in Examples EX2_1 and EX2_2. In addition, in the monitor circuit 17c of FIG. 20, since the method of observing the voltage (Vboot-Vsw) only during the on period of the transistor ML is adopted, the operation of the monitor circuit 17c may be stopped in the sleep mode (see FIG. 4) in which the both off state is maintained. Therefore, the magnitude of a circuit current is unlikely to be an issue, and resistors with sufficiently low resistance values can be used as the resistors 71 and 72. As a result, although a relatively large parasitic capacitance is added to the drain of the transistor 73, which is a high-breakdown voltage element, the influence of the parasitic capacitance is unlikely to occur by making the resistors 71 and 72 low resistance. In addition, since the method of observing the voltage (Vboot-Vsw) only during the on period of the transistor ML is adopted, malfunctions do not occur when the switch voltage Vsw transitions.

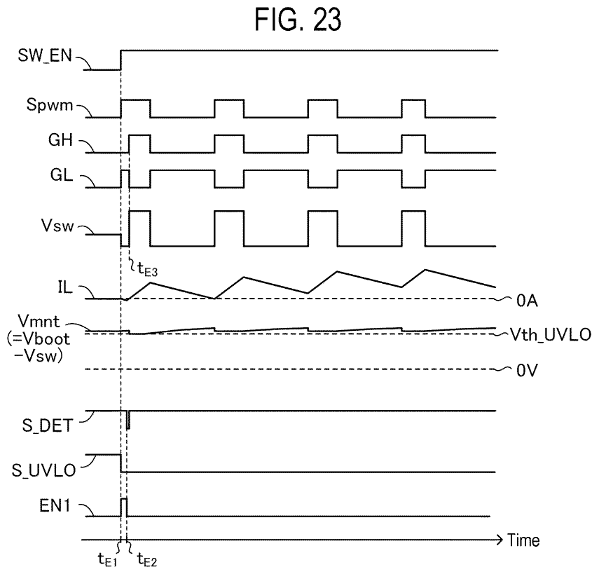

FIG. 22 is a timing chart in the vicinity of the start of switching control and relating to a first case. FIG. 22 shows, from top to bottom, waveforms of the command signal SW_EN, the control signal Spwm, the gate signal GH, the gate signal GL, the switch voltage Vsw, the coil current IL, the monitoring target voltage Vmnt, the detection signal S_DET, the protection signal S_UVLO, and the signal EN1 (the same applies to FIG. 23 to be described later). As time progresses, times t_{D1}, t_{D2}, and t_{D3} occur in this order. In the timing chart of FIG. 22, it is assumed that the charging control CC1 is used (the same applies to FIG. 23 to be described later).

After the switching control is executed, when the operation mode of the switching control circuit 11 is set to the sleep mode, the command signal SW_EN is maintained at a low level for a certain period of time, and thereafter time t_{D1} is reached. Although it is not clear from FIG. 22, it is assumed that the output voltage Vout has a positive voltage close to the target voltage Vtg immediately before time t_{D1}. The logic circuit 13 cancels the latch of the protection signal S_UVLO by the latch circuit 76 when the command signal SW_EN is set to a low level before time t_{D1}, or when a certain period of time has passed after the command signal SW_EN is switched from a high level to a low level before time t_{D1}. By canceling the latch of the protection signal S_UVLO, the level of the protection signal S_UVLO is set to a high level which is an initial level. The protection signal S_UVLO has a high level immediately before time t_{D1}. In addition, immediately before time t_{D1}, the coil current IL is 0 A (zero amperes).

At time t_{D1}, a rising edge occurs in the command signal SW_EN. In response to the rising edge of the command signal SW_EN, the PWM circuit 12 starts generating and outputting the control signal Spwm having a PWM frequency. In the example of FIG. 22, the rising edge occurs in the control signal Spwm at time t_{D1}. The logic circuit 13 responds to the rising edge of the command signal SW_EN and switches the output stage circuit MM from the both off state to the output low state at time t_{D1}. When the output stage circuit MM is switched to the output low state, the monitoring target voltage Vmnt rises due to the charging of the boot capacitor Cboot. On the other hand, a negative coil current IL is generated by turning on the transistor ML in a state where the output voltage Vout is relatively high, and the magnitude (absolute value) of the coil current IL increases from time t_{D1}.

At time t_{D2}, the monitoring target voltage Vmnt reaches the threshold voltage Vth_UVLO. As already mentioned, the monitoring voltage Vmnt reaching the threshold voltage Vth_UVLO refers to the transition from the state where “Vmnt<Vth_UVLO” is established to the state where “Vmnt>Vth_UVLO” or “Vmnt>Vth_UVLO” is established. In the example of FIG. 22, the logic circuit 13 maintains the output stage circuit MM in the output low state and maintains the signal EN1 at the high level, regardless of the control signal Spwm, from time t_{D1} to time t_{D2} when the low-voltage release signal (the low-level detection signal S_DET) is output. Therefore, the monitoring target voltage Vmnt is observed by the monitor circuit 17c between times t_{D1} and t_{D2}. When the monitoring target voltage Vmnt reaches the threshold voltage Vth_UVLO at time t_{D2}, a falling edge occurs in the detection signal S_DET, and a falling edge also occurs in the protection signal S_UVLO in conjunction with the falling edge of the detection signal S_DET. The logic circuit 13 switches the transistor ML from on to off in response to the falling edge of the protection signal S_UVLO, and causes a falling edge to occur in the signal EN1.

Upon receiving the falling edge of the protection signal S_UVLO, the logic circuit 13 enters a state permitting the execution of switching control (in other words, a state permitting the output stage circuit MM to be set to the output high state), and thereafter executes the switching control for the output stage circuit MM in response to the control signal Spwm having a PWM frequency. In the example of FIG. 22, the control signal Spwm has a low level at time t_{D2}, and the next rising edge of the control signal Spwm occurs at time t_{D3}. Therefore, the logic circuit 13 switches the output stage circuit MM from the both off state to the output high state at the rising edge of the control signal Spwm at time t_{D3}, and thereafter continues to execute the switching control. Once the low-voltage release signal is output and the switching control is started, the monitoring target voltage Vmnt does not drop significantly during the switching control, so that monitoring (detection) of the monitoring target voltage Vmnt is not performed. In the timing chart of FIG. 22, in the first half of a period between times t_{D2} and t_{D3}, the negative coil current IL flows through a parasitic diode of the transistor MH, causing the switch voltage Vsw to become equal to the sum of the input voltage Vin and the forward voltage of the parasitic diode, and then, in the second half of the period between times t_{D2} and t_{D3}, “IL=0” is reached, causing the switch voltage Vsw to resonate near the output voltage Vout.

The logic circuit 13 may cancel the latch of the protection signal S_UVLO by the latch circuit 76 and return the level of the protection signal S_UVLO to the initial level (high level) when the command signal SW_EN is set to a low level after time t_{D3}, or when a certain time has passed since the falling edge occurred in the command signal SW_EN after time t_{D3}.

FIG. 23 is a timing chart in the vicinity of the start of switching control and relating to a second case. As time progresses, times t_{E1}, t_{E2}, and t_{E3} occur in this order.

After the switching control is performed, when the operation mode of the switching control circuit 11 is set to the sleep mode, the command signal SW_EN is maintained at a low level for a certain period of time, and thereafter time t_{E1} is reached. Although it is not clear from FIG. 23, it is assumed that the output voltage Vout has a positive voltage close to the target voltage Vtg immediately before time t_{E1}. The logic circuit 13 cancels the latch of the protection signal S_UVLO by the latch circuit 76 when the command signal SW_EN is set to a low level before time t_{E1}, or when a certain period of time has passed after the command signal SW_EN is switched from a high level to a low level before time t_{E1}. By canceling the latch of the protection signal S_UVLO, the level of the protection signal S_UVLO is set to a high level which is an initial level. The protection signal S_UVLO has a high level immediately before time t_{E1}. In addition, immediately before time t_{E1}, the coil current IL is 0 A (zero amperes).

A rising edge occurs in the command signal SW_EN at time t_{E1}. In response to the rising edge of the command signal SW_EN, the PWM circuit 12 starts generating and outputting the control signal Spwm having a PWM frequency. In the example of FIG. 23, the rising edge occurs in the control signal Spwm at time t_{E1}. The logic circuit 13 responds to the rising edge of the command signal SW_EN and switches the output stage circuit MM from the both off state to the output low state at time t_{E1}. The logic circuit 13 maintains the output stage circuit MM in the output low state and maintains the signal EN1 at the high level, regardless of the control signal Spwm, from time t_{E1} to time t_{E2} when the low-voltage release signal (the low-level detection signal S_DET) is output. Therefore, the monitoring target voltage Vmnt is observed by the monitor circuit 17c between times t_{E1} and t_{E2}.

In the second case corresponding to FIG. 23, the stop period of the switching control existing before the rising edge of the command signal SW_EN is shorter than that in the first case corresponding to FIG. 22, and therefore the monitoring target voltage Vmnt at time t_{E1} is equal to or greater than the threshold voltage Vth_UVLO, or the monitoring target voltage Vmnt reaches the threshold voltage Vth_UVLO immediately after time t_{E1}. Therefore, a falling edge occurs in the detection signal S_DET at time t_{E2} immediately after time t_{E1}. In response to the falling edge of the detection signal S_DET at time t_{E2}, a falling edge also occurs in the protection signal S_UVLO, and then a falling edge also occurs in the signal EN1. In this second case, without waiting for the next cycle of the control signal Spwm, the logic circuit 13 switches the transistor MH from off to on in accordance with the high-level control signal Spwm at time t_{E3} immediately after time t_{E2} (a rising edge occurs in the control signal Spwm at time t_{E1}, and a falling edge occurs in the control signal Spwm after times t_{E2} and t_{E3}). In other words, after setting the output stage circuit MM to the output low state at time t_{E1}, the output stage circuit MM is set to the output high state at time t_{E3} without being set to the both off state (however, there is a setting of the both off state due to dead time). This makes it possible to reduce a decrease in the output voltage Vout.

The logic circuit 13 may cancel the latching of the protection signal S_UVLO by the latch circuit 76 and return the level of the protection signal S_UVLO to the initial level (high level) when the command signal SW_EN is set to a low level after time t_{E3}, or when a certain amount of time has passed since the falling edge occurred in the command signal SW_EN after time t_{E3}.

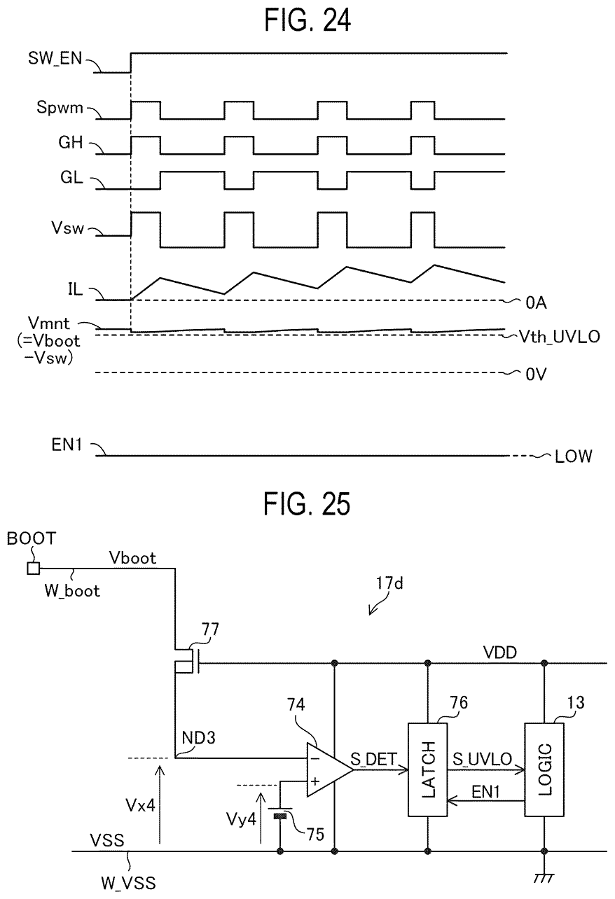

FIG. 24 is a timing chart in the vicinity of the start of switching control after a short period of stop of switching control and relating to a third case. After the switching control is executed and thereafter the switching control is stopped due to a falling edge of the command signal SW_EN, when a rising edge occurs in the command signal SW_EN before the length of the switching control stop period reaches the above-mentioned discharging reference time Tdis (see FIG. 13 to FIG. 15), it is considered that the discharging of the boot capacitor Cboot has hardly progressed, and therefore, as shown in FIG. 24, the logic circuit 13 may directly transition the output stage circuit MM from the both off state to the output high state without performing the charging control involving turning on the transistor ML.

### Example EX2_4

Example EX2_4 will be described. FIG. 25 shows a configuration of a monitor circuit 17d, which is the monitor circuit 17 according to Example EX2_4. The monitor circuit 17d includes a transistor 77 (insertion transistor), a comparator 74, a reference voltage source 75, and a latch circuit 76. The transistor 77 is an N-channel MOSFET. In the monitor circuit 17c of FIG. 20, the voltage between the voltages Vboot and VSS is divided before being input to the comparator 74, but in the monitor circuit 17d of FIG. 25, the boot voltage Vboot is clamped by the transistor 77 to prevent an overvoltage from being input to the comparator 74.

Specifically, the drain of the transistor 77 is connected to the boot terminal BOOT and the boot wiring W_boot and receives the boot voltage Vboot. The source of the transistor 77 is connected to a node ND3. That is, the transistor 77 is provided between the boot wiring W_boot and the node ND3. The power supply voltage VDD of the switching control circuit 11 is input to the gate of the transistor 77. A voltage at the node ND3 is referred to as a voltage Vx4. The transistor 77 limits the voltage Vx4 to a voltage (VDD−Vth77) or less so that the voltage Vx4 does not exceed the breakdown voltage of the comparator 74. The voltage (VDD−Vth77) is a voltage lower by the gate threshold voltage Vth77 of the transistor 77 than the power supply voltage VDD. The lower of the boot voltage Vboot and the voltage (VDD−Vth77) is applied to the node ND3.

The comparator 74, the reference voltage source 75, and the latch circuit 76 in the monitor circuit 17d have the same configuration and operation as the comparator 74, the reference voltage source 75, and the latch circuit 76 in the monitor circuit 17c (FIG. 20). However, in the monitor circuit 17d, the inverting input terminal of the comparator 74 is connected to the node ND3 and receives the voltage Vx4 at the node ND3. In addition, in the monitor circuit 17d, the reference voltage source 75 generates a predetermined positive reference voltage Vy4 based on the ground potential and supplies the generated reference voltage Vy4 to the non-inverting input terminal of the comparator 74. Therefore, the comparator 74 in the monitor circuit 17d compares the voltage Vx4 at its inverting input terminal with the voltage Vy4 at its non-inverting input terminal and outputs the detection signal S_DET indicating the high/low relationship between them. The detection signal S_DET in the monitor circuit 17d has a high level when “Vx4<Vy4” is established, a low level when “Vx4>Vy4” is established, and a low level or a high level when “Vx4=Vy4” is established. The reference voltage Vy4 is lower than the voltage (VDD−Vth77).

The voltage Vx4 during the on period of the transistor ML is specifically referred to as an evaluation voltage Vx4. As described above, since the switch voltage Vsw is approximately equal to the voltage VSS during the on period of the transistor ML, when “Vboot<VDD−Vth77”, the evaluation voltage Vx4 is substantially equal to the monitoring target voltage Vmnt. In other words, the monitor circuit 17d may generate the evaluation voltage Vx4, which corresponds to the monitoring target voltage Vmnt (=Vboot−Vsw), at the node ND3 during the on period of the transistor ML. The monitor circuit 17d compares the evaluation voltage Vx4 with the reference voltage Vy4 to determine whether or not to supply the low-voltage release signal to the logic circuit 13. When “Vboot≥VDD−Vth77” during the on period of the transistor ML, the voltage (VDD−Vth77) higher than the reference voltage Vy4 is supplied to the inverting input terminal of the comparator 74 and generates the low-level detection signal S_DET. However, since the state where “Vboot≥VDD−Vth77” during the on period of the transistor ML corresponds to the state where “Vmnt≥Vth_UVLO” during the on period of the transistor ML, there is no problem.

When the output stage circuit MM is in the output high state or in the both off state, the detection signal S_DET is invalid. The logic circuit 13 supplies the signal EN1 for controlling the latch operation of the latch circuit 76 to the latch circuit 76. When controlling the charging of the boot capacitor Cboot, the logic circuit 13 only needs to set the signal EN1 to a high level during the on period of the transistor ML. The logic circuit 13 sets the signal EN1 to a low level during the period when the output stage circuit MM is set to the output high state and during the period when the output stage circuit MM is set to the both off state. The latch circuit 76 invalidates the detection signal S_DET during the low-level period of the signal EN1 and does not respond to the detection signal S_DET during the low-level period of the signal EN1.

In the initial state of the power supply control device 10, the protection signal S_UVLO from the latch circuit 76 has a high level, and the protection signal S_UVLO has a high level in principle. The latch circuit 76 monitors the level of the detection signal S_DET during the high-level period of the signal EN1 (hence during the on period of the transistor ML). During the high-level period of the signal EN1, when a falling edge occurs in the detection signal S_DET, the latch circuit 76 latches the low level of the detection signal S_DET to switch the level of the protection signal S_UVLO from a high level to a low level (see FIG. 21). As described above, the low-level detection signal S_DET or the low-level protection signal S_UVLO functions as a low-voltage release signal (charging completion signal). The latch circuit 76 may be built into the logic circuit 13. Under the assumption that the transistor ML is turned on, each constant in the monitor circuit 17d is set so that the detection signal S_DET of the comparator 74 switches from a high level to a low level at the point when the voltage (Vboot-Vsw) rises and reaches the threshold voltage Vth_UVLO.

The transistor 77 is a high-breakdown voltage element. In the monitor circuit 17d of FIG. 25, there is no need to use any high-breakdown voltage element other than the transistor 77. Therefore, in the monitor circuit 17d in FIG. 25, the size of the monitor circuit on the semiconductor chip may be made smaller than that of the monitor circuits 17a and 17b shown in Examples EX2_1 and EX2_2. In the monitor circuit 17c of FIG. 20, since voltage division is used, the reference voltage Vy3 supplied to the comparator 74 may be freely set. In contrast, the monitor circuit 17d of FIG. 25 is restricted to set the reference voltage Vy4 to be lower than the voltage (VDD−Vth77). However, since the monitor circuit 17d does not use a voltage dividing resistor, the input signal (Vx4) to the comparator 74 may be made to have a low impedance, and as a result, the monitor circuit 17d is even less susceptible to the effects of parasitic capacitance than the monitor circuit 17c. Further, a circuit current flowing through the voltage dividing resistor is zero in the monitor circuit 17d.

### Example EX2_5

Example EX2_5 will be described. An additional description will be given of the operation in a case where the monitor circuit 17c according to Example EX2_3 and the monitor circuit 17d according to Example EX2_4 are used as the monitor circuit 17 of FIG. 1.

Both monitor circuits 17c and 17d employ a method of observing the monitoring target voltage Vmnt (=Vboot−Vsw) only during the on period of the transistor ML, and a voltage corresponding to the monitoring target voltage Vmnt does not occur in the monitor circuits 17c and 17d during the off period of the transistor ML. The switching control circuit 11 maintains the transistor MH in the off state until the low-voltage release signal indicating that the monitoring target voltage Vmnt has reached the threshold voltage Vth_UVLO is supplied from the monitor circuit 17c or 17d. The advantages obtained by employing the method of observing the monitoring target voltage Vmnt only during the on period of the transistor ML are as shown in Example EX2_3 or EX2_4.

When the switching control circuit 11 starts the switching control in response to an execution command signal (high-level command signal SW_EN) that commands the execution of the switching control after keeping the transistors MH and ML off by stopping the switching control, the switching control circuit 11 executes the charging control accompanied by observation of the monitoring target voltage Vmnt before starting the switching control. In this charging control, the switching control circuit 11 charges the boot capacitor Cboot by providing a charging period in which the transistor ML is turned on while keeping the transistor MH off, to cause the monitor circuit 17c or 17d to observe the monitoring target voltage Vmnt during the charging period.

Here, it is assumed that the charging control CC1 is used as the charging control in Example EX2_3 (see FIG. 22). The charging control CC1 may also be used in Example EX2_4. In the charging control CC1, the switching control circuit 11 keeps the transistor ML on continuously until the low-voltage release signal is output from the monitor circuit 17c or 17d.

However, in Examples EX2_3 and EX2_4, the charging control CC2 (see FIG. 11, or the like) described in the first embodiment may be used. In this case, the switching control circuit 11 may set the transistor ML to be on intermittently in the charging control CC2 until the low-voltage release signal is output from the monitor circuit 17c or 17d. Details of the operation of the switching control circuit 11 related to the charging control CC2 are as shown in the first embodiment.

In the second embodiment, the state transition of the logic circuit 13 when the charging control CC2 is used may follow that shown in FIG. 12 or 13. That is, when the switching control circuit 11 starts the switching control based on the reception of the execution command signal (high-level command signal SW_EN) after keeping the transistors MH and ML off by stopping the switching control, the switching control circuit 11 executes the charging control CC2 (the operation of only the state ST2 or the operation involving the transition between the states ST2 and ST3) before the start of the switching control, and does not execute the charging control CC2 during the execution period of the switching control. The same applies when the charging control CC1 is used in the second embodiment, and the state transition diagram of the logic circuit 13 is similar to that of FIG. 12 or 13. However, when the charging control CC1 is used, the state ST3 is deleted from the state transition diagrams of FIG. 12 and FIG. 13, and it is understood that there is no transition between the states ST2 and ST3. Even when the charging control CC1 is used, as when the charging control CC2 is used, the switching control circuit 11 maintains the transistors MH and ML off by stopping the switching control, and then when starting the switching control based on the reception of the execution command signal (high-level command signal SW_EN), executes the charging control CC1 (the operation of only the state ST2) before the start of the switching control, and does not execute the charging control CC1 during the execution period of the switching control.

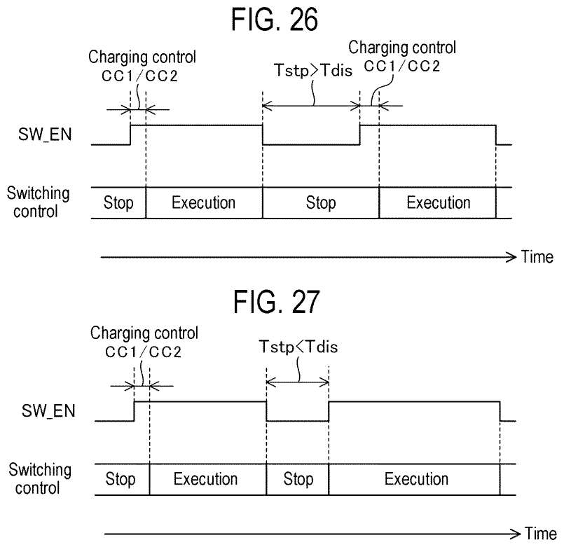

In the second embodiment, when the state transition of the logic circuit 13 in the case where the charging control CC1 or CC2 is used follows that shown in FIG. 13, the operation of the switching control circuit 11 is as follows. That is, when the switching control circuit 11 receives the execution command signal (high-level command signal SW_EN) that commands the execution of the switching control while the logic circuit 13 is in the state ST1, the switching control circuit 11 transitions to the state ST4 via the charging control CC1 or CC2 and starts the switching control. The charging control CC1 is implemented only in the state ST2. The charging control CC2 may be implemented only in the state ST2, or may involve the transition between the states ST2 and ST3. After that, when the switching control circuit 11 receives the stop command signal (low-level command signal SW_EN) that commands the stop of the switching control, the switching control circuit 11 stops the switching control and measures the elapsed time Tstp from the stop of the switching control based on the stop command signal. When the execution command signal (high-level command signal SW_EN) is received again after the elapsed time Tstp reaches the discharging reference time Tdis, the switching control circuit 11 restarts the switching control after going through the charging control CC1 or CC2 again, as shown in FIG. 26. On the other hand, when the execution command signal is received again before the elapsed time Tstp reaches the discharging reference time Tdis, the switching control circuit 11 restarts the switching control without going through the charging control CC1 or CC2 again, as shown in FIG. 27.

### <<Supplements>>

Supplementary matters on the above-described embodiments will be described.

The switching power supply device 1 of FIG. 1 may be mounted in any electrical device. The electrical device may be electrical equipment mounted in a vehicle such as an automobile, a computer device, or a home appliance or industrial device.

A composite power supply device including the switching power supply device 1 may be formed. The composite power supply device includes a plurality of switching power supply devices, or includes one or more switching power supply devices (switching regulators) and one or more linear regulators. A power supply control device provided in the composite power supply device may be a so-called PMIC (Power Management IC).

For any signal or voltage, its high level/low level relationship may be reversed to that described above without departing from the spirit of the above discussion.

The type of channel of the FET (Field Effect Transistor) shown in the above-described embodiments is an example. The type of channel of any FET may be changed between P-channel type and N-channel type without departing from the spirit of the above discussion.

Any of the transistors described above may be any type of transistor as long as it does not cause any inconvenience. For example, any transistor described above as a MOSFET may be replaced with a junction FET, an IGBT (Insulated Gate Bipolar Transistor), or a bipolar transistor as long as it does not cause any inconvenience. Any transistor has a first electrode, a second electrode, and a control electrode. In the FET, one of the first and second electrodes is the drain, the other is the source, and the control electrode is the gate. In the IGBT, one of the first and second electrodes is the collector, the other is the emitter, and the control electrode is the gate. In the bipolar transistor not belonging to the IGBT, one of the first and second electrodes is the collector, the other is the emitter, and the control electrode is the base.

The embodiments of the present disclosure may be appropriately modified in various ways within the scope of the technical ideas indicated in the claims. The above embodiments are merely examples of the embodiments of the present disclosure, and the meanings of the terms of the present disclosure and each constituent element are not limited to those described in the above embodiments. The specific numerical values given in the above description are merely examples and can, of course, be changed to various numerical values.

### <<First Supplementary Note>>

A first supplementary note is provided for the technique that mainly corresponds to the first embodiment.

A power supply control device according to one aspect of the present disclosure (see FIG. 1 and FIG. 11) is a power supply control device 10 provided in a switching power supply device 1 configured to generate an output voltage Vout from an input voltage Vin by DC/DC conversion, wherein the switching power supply device is provided with an output stage circuit MM having a high-side transistor MH provided between an application terminal IN of the input voltage and a switch terminal SW, and a low-side transistor ML provided between the switch terminal and a ground terminal GND having a ground potential lower than the input voltage, and the output voltage is generated by rectifying and smoothing a switch voltage Vsw, which is generated at the switch terminal through on/off control of the high-side transistor and the low-side transistor, using a coil L1 and an output capacitor Cout,
the power supply control device includes:
a high-side driver 14 configured to drive the gate of the high-side transistor;
a low-side driver 15 configured to drive the gate of the low-side transistor;
a switching control circuit 11 configured to control the on/off state of the high-side transistor and the low-side transistor using the low-side driver and the high-side driver based on a feedback voltage Vfb corresponding to the output voltage;
a boot terminal BOOT connected to the switch terminal via a boot capacitor Cboot and configured to apply a boot voltage Vboot that functions as a high-potential-side power supply voltage for the high-side driver;
a rectifying element Dboot configured to supply a charging current to the boot capacitor during an on period of the low-side transistor with the switch terminal set to a low-potential-side;
a reverse current detection circuit 16 configured to detect a specific reverse current state in which a predetermined amount or more of reverse current flows from an output terminal OUT to which the output voltage is applied, toward the low-side transistor via the coil and the switch terminal; and
a monitor circuit 17 configured to monitor a height of the boot voltage as viewed from the switch voltage, as a monitoring target voltage Vmnt,
the switching control circuit sets the state of the output stage circuit to an output high state in which the high-side transistor is turned on and the low-side transistor is turned off, an output low state in which the high-side transistor is turned off and the low-side transistor is turned on, or a both off state in which both the high-side transistor and the low-side transistor are turned off, and
the switching control circuit:
maintains the output stage circuit in the output low state after setting the output stage circuit in the output low state in a state where the monitoring target voltage is lower than a threshold voltage Vth_UVLO, until the monitoring target voltage reaches the threshold voltage or the specific reverse current state is detected;
when the specific reverse current state is detected before the monitoring target voltage reaches the threshold voltage in a state where the output stage circuit is set to the output low state, executes a reverse current limiting operation J2 to switch the state of the output stage circuit to the both off state and to return the output stage circuit to the output low state after maintaining the output stage circuit in the both off state for a predetermined waiting time Tw; and
permits the output stage circuit to be set to the output high state when the monitoring target voltage reaches the threshold voltage (hereinafter, referred to as Configuration A1).

With this configuration, it is possible to suppress the occurrence of a large reverse current when charging the boot capacitor and to protect the low-side transistor from an excessively large reverse current. In addition, an excessive drop in the output voltage due to the reverse current are prevented, and adverse effects on a load (load driven based on the output voltage) due to a drop in the output voltage are also suppressed.

In the power supply control device of Configuration A1 (see FIG. 1 and FIG. 11), the switching control circuit may be configured to start switching control to alternately turn on and off the high-side transistor and the low-side transistor based on a control signal Spwm generated according to the feedback voltage after the monitoring target voltage reaches the threshold voltage (hereinafter, referred to as Configuration A2).

In the power supply control device of Configuration A2 (see FIG. 9 and FIG. 10), the reverse current detection circuit may be configured to be able to detect a first reverse current state in which the magnitude of the reverse current exceeds a first current threshold value Isht1 during an execution period of the switching control, wherein the switching control circuit sets the output stage circuit to the output low state based on the control signal during the execution period of the switching control, and then executes a reverse current prevention operation J1 to switch the output stage circuit from the output low state to the both off state regardless of the control signal when the first reverse current state is detected by the reverse current detection circuit, and wherein the reverse current detection circuit detects a second reverse current state in which the magnitude of the reverse current exceeds a second current threshold value Isht2 larger than the first current threshold value, as the specific reverse current state, using the same circuit as a circuit for detecting the first reverse current state (hereinafter, referred to as Configuration A3).

The reverse current prevention operation accompanying the detection of the first reverse current state improves efficiency during a light load. By using the same circuit as a circuit provided to improve efficiency under the light load and shifting the current threshold value, it is possible to detect a specific reverse current state (second reverse current state) when charging the boot capacitor. Therefore, only a small amount of circuitry needs to be added to achieve the reverse current limiting operation (the increase in chip cost is only a small amount).

In the power supply control device of Configuration A3 (see FIG. 11), when the switching control is started upon receiving an execution command signal (high-level command signal SW_EN) that commands the execution of the switching control, the switching control circuit may be configured to execute charging control CC2 before the start of the switching control, wherein the switching control circuit executes, in the charging control, an operation of maintaining the output stage circuit in the output low state after setting the output stage circuit to the output low state in the state where the monitoring target voltage is lower than the threshold voltage, until the monitoring target voltage reaches the threshold voltage or the specific reverse current state is detected, and executes the reverse current limiting operation when the specific reverse current state is detected before the monitoring target voltage reaches the threshold voltage in the state in which the output stage circuit is set to the output low state, and wherein the switching control circuit starts the switching control after the monitoring target voltage reaches the threshold voltage after the start of the charging control (hereinafter, referred to as Configuration A4).

In the power supply control device of Configuration A4 (see FIG. 11 and FIG. 12), when the switching control is started based on the reception of the execution command signal after a stop period of the switching control, the switching control circuit may be configured to execute the charging control before the start of the switching control and not execute the charging control during the execution period of the switching control (hereinafter, referred to as Configuration A5).

In the power supply control device of Configuration A4 or A5 (see FIG. 13 to FIG. 15), the switching control circuit may be configured to: receive the execution command signal, start the switching control after going through the charging control, and then stop the switching control and measure the elapsed time Tstp since the stopping of the switching control upon receiving a stop command signal (low-level command signal SW_EN) that commands the stopping of the switching control; restart the switching control after going through the charging control again upon receiving the execution command signal again after the elapsed time reaches a predetermined time Tdis; and restart the switching control without going through the charging control again upon receiving the execution command signal again before the elapsed time reaches the predetermined time (hereinafter, referred to as Configuration A6).

With this configuration, it is expected to improve power efficiency or response performance as compared to a case where charging control is always performed before switching control is started each time an execution command signal is received.

### <<Second Supplementary Note>>

A second supplementary note is provided for the technique that mainly corresponds to the second embodiment.

A power supply control device according to another aspect of the present disclosure (see FIG. 1 and FIG. 20 or 25) is a power supply control device 10 provided in a switching power supply device 1 configured to generate an output voltage Vout from an input voltage Vin by DC/DC conversion, wherein the switching power supply device is provided with an output stage circuit MM having a high-side transistor MH provided between an application terminal IN of the input voltage and a switch terminal SW, and a low-side transistor ML provided between the switch terminal and a ground terminal GND having a ground potential lower than the input voltage, and the output voltage is generated by rectifying and smoothing a switch voltage Vsw, which is generated at the switch terminal through on/off control of the high-side transistor and the low-side transistor, using a coil L1 and an output capacitor Cout,
the power supply control device including:
a high-side driver 14 configured to drive the gate of the high-side transistor;
a low-side driver 15 configured to drive the gate of the low-side transistor;
a switching control circuit 11 configured to control the on/off state of the high-side transistor and the low-side transistor using the low-side driver and the high-side driver based on a feedback voltage Vfb corresponding to the output voltage;
a boot terminal BOOT connected to the switch terminal via a boot capacitor Cboot and configured to apply a boot voltage Vboot that functions as a high-potential-side power supply voltage for the high-side driver;
a rectifying element Dboot configured to supply a charging current to the boot capacitor during an on period of the low-side transistor with the switch terminal set to a low-potential-side; and
a monitor circuit 17 configured to monitor a height of the boot voltage as viewed from the switch voltage, as a monitoring target voltage Vmnt,
wherein the monitor circuit observes the monitoring target voltage only during the on period of the low-side transistor, and
wherein the switching control circuit maintains the high-side transistor off until a low-voltage release signal indicating that the monitoring target voltage reaches a threshold voltage Vth_UVLO is supplied from the monitor circuit (hereinafter, referred to as Configuration B1).

During the on period of the low-side transistor, a voltage between the boot terminal and the switch terminal is substantially equal to a voltage between the boot terminal and the ground terminal. Therefore, by detecting the voltage between the boot terminal and the ground terminal during the on period of the low-side transistor, it is possible to observe the voltage between the boot terminal and the switch terminal (that is, the monitoring target voltage). By adopting such a method, it is possible to reduce the number of high-breakdown voltage elements used, and therefore the size of the monitor circuit.

In the power supply control device of Configuration B1 (see FIG. 20), the monitor circuit may be configured to have a voltage dividing circuit 71 (or 72) provided between a reference wiring W_VSS having the ground potential and a boot wiring W_boot to which the boot voltage is applied, wherein the voltage dividing circuit divides a voltage between the reference wiring and the boot wiring during the on period of the low-side transistor to generate an evaluation voltage Vx3 corresponding to the monitoring target voltage, and wherein it is determined whether or not to supply the low-voltage release signal to the switching control circuit based on the evaluation voltage (hereinafter, referred to as Configuration B2).

With this configuration, it is possible to reduce the number of high-breakdown voltage elements used, and therefore the size of the monitor circuit. In addition, by adopting a method of observing the monitoring target voltage only in the on period of the low-side transistor, the operation of the monitor circuit may be stopped in a sleep mode, or the like. Therefore, the magnitude of the circuit current is unlikely to be an issue, and the voltage dividing circuit may be formed using resistors with sufficiently low resistance values. As a result, although a relatively large parasitic capacitance is added to the high-breakdown voltage element, the influence of the parasitic capacitance is unlikely to occur. In addition, by adopting the method of observing the monitoring target voltage only in the on period of the low-side transistor, there is no risk of malfunction occurring when the switch voltage transitions.

In the power supply control device of Configuration B2, the voltage dividing circuit may be configured to include: a first voltage dividing resistor 71 provided between the boot wiring and a first node; a second voltage dividing resistor 72 provided between a second node and the reference wiring; and an insertion transistor 73 interposed between the first node and the second node and controlled to be turned on during the on period of the low-side transistor, wherein the monitor circuit uses a voltage at the second node during the on periods of the low-side transistor and the insertion transistor, as the evaluation voltage, to determine whether or not to supply the low-voltage release signal to the switching control circuit by comparing the evaluation voltage with a voltage Vy3 that is higher by a predetermined voltage than the ground potential (hereinafter, referred to as Configuration B3).

In the power supply control device of Configuration B1 (see FIG. 25), the monitor circuit may be configured to have an insertion transistor 77 provided between a boot wiring W_boot to which the boot voltage is applied and a specific node ND3 and configured to receive a power supply voltage VDD of the switching control circuit at the gate of the insertion transistor, generate an evaluation voltage Vx4 corresponding to the monitoring target voltage at the specific node during the on period of the low-side transistor, and determine whether or not to supply the low-voltage release signal to the switching control circuit based on the evaluation voltage (hereinafter, referred to as Configuration B4).

With this configuration, it is possible to reduce the number of high-breakdown voltage elements, and therefore the size of the monitor circuit. In addition, although a relatively large parasitic capacitance is added to the high-breakdown voltage element, there is no need to use a voltage dividing resistor, making it possible to reduce the impedance of a signal at the specific node and making it difficult for the influence of the parasitic capacitance to occur. In addition, by adopting the method of observing the monitoring target voltage only in the on period of the low-side transistor, there is no risk of malfunction occurring when the switch voltage transitions.

In the power supply control device of Configuration B4, the specific node may be applied with the lower of the boot voltage and a voltage lower by the gate threshold voltage of the insertion transistor than the power supply voltage of the switching control circuit, and the monitor circuit may be configured to determine whether or not to supply the low-voltage release signal to the switching control circuit by comparing the evaluation voltage with a voltage Vy4 that is higher by a predetermined voltage than the ground potential (hereinafter, referred to as Configuration B5).

In the power supply control device of any one of Configurations B1 to B5, the switching control circuit may be configured to perform switching control that alternately turns on and off the high-side transistor and the low-side transistor based on a control signal Spwm generated according to the feedback voltage, and to start the switching control after receiving the supply of the low-voltage release signal (hereinafter, referred to as Configuration B6).

In the power supply control device of Configuration B6, when the switching control is started upon receiving an execution command signal (high-level command signal SW_EN) that commands the execution of the switching control after maintaining the high-side transistor and the low-side transistor off by stopping the switching control, the switching control circuit may be configured to: execute charging control CC1 (or CC2) accompanied by observation of the monitoring target voltage before the start of the switching control; charge the boot capacitor by providing a charging period in which the high-side transistor is maintained off and the low-side transistor is turned on in the charging control; and cause the monitor circuit to observe the monitoring target voltage during the charging period (hereinafter, referred to as Configuration B7).

In the power supply control device of Configuration B7, the switching control circuit may be configured to keep the low-side transistor continuously on during the charging control until the low-voltage release signal is output from the monitor circuit (hereinafter, referred to as Configuration B8).

In the power supply control device of Configuration B7, the switching control circuit may be configured to set the low-side transistor to intermittently on during the charging control until the low-voltage release signal is output from the monitor circuit (hereinafter, referred to as Configuration B9).

In the power supply control device of any one of Configurations B7 to B9, the switching control circuit may be configured to execute the charging control before the start of the switching control when the switching control is started based on the reception of the execution command signal after the stop period of the switching control, and to not execute the charging control during the execution period of the switching control (hereinafter, referred to as Configuration B10).

In the power supply control device of Configurations B7 to B9 (see FIG. 26 and FIG. 27), the switching control circuit may be configured to: receive the execution command signal, start the switching control after going through the charging control, and then stop the switching control and measure the elapsed time Tstp since the stopping of the switching control upon receiving a stop command signal (low-level command signal SW_EN) that commands the stopping of the switching control; restart the switching control after going through the charging control again upon receiving the execution command signal again after the elapsed time reaches a predetermined time Tdis; and restart the switching control without going through the charging control again upon receiving the execution command signal again before the elapsed time reaches the predetermined time (hereinafter, referred to as Configuration B11).

With this configuration, it is expected to improve power efficiency or response performance as compared to a case where charging control is always performed before switching control is started each time an execution command signal is received.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A power supply control device provided in a switching power supply device configured to generate an output voltage from an input voltage by DC/DC conversion, wherein the switching power supply device is provided with an output stage circuit having a high-side transistor provided between an application terminal of the input voltage and a switch terminal, and a low-side transistor provided between the switch terminal and a ground terminal having a ground potential lower than the input voltage, and the output voltage is generated by rectifying and smoothing a switch voltage, which is generated at the switch terminal through on/off control of the high-side transistor and the low-side transistor, using a coil and an output capacitor,
the power supply control device comprising:
a high-side driver configured to drive a gate of the high-side transistor;
a low-side driver configured to drive a gate of the low-side transistor;
a switching control circuit configured to control the on/off state of the high-side transistor and the low-side transistor using the low-side driver and the high-side driver based on a feedback voltage corresponding to the output voltage;
a boot terminal connected to the switch terminal via a boot capacitor and configured to apply a boot voltage that functions as a high-potential-side power supply voltage for the high-side driver;
a rectifying element configured to supply a charging current to the boot capacitor during an on period of the low-side transistor with the switch terminal set to a low-potential-side;
a reverse current detection circuit configured to detect a specific reverse current state in which a predetermined amount or more of reverse current flows from an output terminal to which the output voltage is applied, toward the low-side transistor via the coil and the switch terminal; and
a monitor circuit configured to monitor a height of the boot voltage as viewed from the switch voltage, as a monitoring target voltage,
wherein the switching control circuit sets the state of the output stage circuit to an output high state in which the high-side transistor is turned on and the low-side transistor is turned off, an output low state in which the high-side transistor is turned off and the low-side transistor is turned on, or a both off state in which both the high-side transistor and the low-side transistor are turned off, and
wherein the switching control circuit:
maintains the output stage circuit in the output low state after setting the output stage circuit in the output low state in a state where the monitoring target voltage is lower than a threshold voltage, until the monitoring target voltage reaches the threshold voltage or the specific reverse current state is detected;
when the specific reverse current state is detected before the monitoring target voltage reaches the threshold voltage in a state where the output stage circuit is set to the output low state, executes a reverse current limiting operation to switch the state of the output stage circuit to the both off state and to return the output stage circuit to the output low state after maintaining the output stage circuit in the both off state for a predetermined waiting time; and
permits the output stage circuit to be set to the output high state when the monitoring target voltage reaches the threshold voltage.

2. The power supply control device of claim 1, wherein the switching control circuit starts switching control to alternately turn on and off the high-side transistor and the low-side transistor based on a control signal generated according to the feedback voltage after the monitoring target voltage reaches the threshold voltage.

3. The power supply control device of claim 2, wherein the reverse current detection circuit is configured to be able to detect a first reverse current state in which a magnitude of the reverse current exceeds a first current threshold value during an execution period of the switching control,
wherein the switching control circuit sets the output stage circuit to the output low state based on the control signal during the execution period of the switching control, and subsequently executes a reverse current prevention operation to switch the output stage circuit from the output low state to the both off state regardless of the control signal when the first reverse current state is detected by the reverse current detection circuit, and
wherein the reverse current detection circuit detects a second reverse current state in which the magnitude of the reverse current exceeds a second current threshold value larger than the first current threshold value, as the specific reverse current state, using a same circuit as a circuit for detecting the first reverse current state.

4. The power supply control device of claim 2, wherein, when the switching control is started upon receiving an execution command signal that commands the execution of the switching control, the switching control circuit executes charging control before the start of the switching control,
wherein the switching control circuit executes, in the charging control, an operation of maintaining the output stage circuit in the output low state after setting the output stage circuit to the output low state in the state where the monitoring target voltage is lower than the threshold voltage, until the monitoring target voltage reaches the threshold voltage or the specific reverse current state is detected, and executes the reverse current limiting operation when the specific reverse current state is detected before the monitoring target voltage reaches the threshold voltage in the state in which the output stage circuit is set to the output low state, and
wherein the switching control circuit starts the switching control after the monitoring target voltage reaches the threshold voltage after the start of the charging control.

5. The power supply control device of claim 4, wherein, when the switching control is started based on the reception of the execution command signal after a stop period of the switching control, the switching control circuit executes the charging control before the start of the switching control and does not execute the charging control during the execution period of the switching control.

6. The power supply control device of claim 4, wherein the switching control circuit: receives the execution command signal, starts the switching control after going through the charging control, and subsequently stops the switching control and measures an elapsed time since the stopping of the switching control upon receiving a stop command signal that commands the stopping of the switching control; restarts the switching control after going through the charging control again upon receiving the execution command signal again after the elapsed time reaches a predetermined time; and restarts the switching control without going through the charging control again upon receiving the execution command signal again before the elapsed time reaches the predetermined time.
